(19) United States
(12) Patent Application Publication
(10) Pub. No.: US 2026/0067922 A1
(43) Pub. Date: Mar. 5, 2026

(54) MAINTAINING AND SHARING OF AN OVERLAPPING BASIC SERVICE SET (OBSS) INFORMATION SET TO SUPPORT NPCA (NON-PRIMARY CHANNEL ACCESS) OPERATIONS

(71) Applicant: NEWRACOM, Inc., Irvine, CA (US)

(72) Inventors: Joonsoo LEE, Irvine, CA (US); Si-Chan NOH, Seoul (KR)

(73) Assignee: NEWRACOM, Inc., Irvine, CA (US)

(21) Appl. No.: 19/296,869

(22) Filed: Aug. 11, 2025

Related U.S. Application Data
(60) Provisional application No. 63/688,389, filed on Aug. 29, 2024.

(51) Int. Cl. H04W 74/00

(52) U.S. Cl. CPC H04W 74/002

(57) ABSTRACT

Disclosed herein is a method performed by a wireless device belonging to a basic service set (BSS) to perform non-primary channel access (NPCA). The method includes maintaining local overlapping basic service set (OBSS) information set and peer OBSS information set for a peer wireless device. The peer OBSS information set includes information regarding whether the peer wireless device can obtain NPCA information from preambles transmitted by one or more OBSSs and information regarding rates or modulation coding schemes receivable by the peer wireless device from the one or more OBSSs. The method further includes determining, based on the peer OBSS information set for the peer wireless device, whether the peer wireless device can perform NPCA during transmission of the PPDU and performing NPCA with the peer wireless device in a NPCA primary channel in response to determining that the peer wireless device can perform NPCA.

### CROSS-REFERENCE TO RELATED APPLICATION

This application claims the benefit of U.S. Provisional Application No. 63/688,389, filed Aug. 29, 2024, titled “Method for constructing a set of information from received OBSS (Overlapping Basic Service Set) signals to support NPCA (Non-primary Channel Access) operation”, which is hereby incorporated by reference.

### TECHNICAL FIELD

The present disclosure generally relates to wireless communications, and more specifically, relates to maintaining and sharing of an overlapping basic service set (OBSS) information set to support non-primary channel access (NPCA) operations.

### BACKGROUND

Institute of Electrical and Electronics Engineers (IEEE) 802.11 is a set of standards for implementing wireless local area network communication in various frequencies, including but not limited to the 2.4 gigahertz (GHz), 5 GHz, 6 GHz, and 60 GHz bands. These standards define the protocols that enable Wi-Fi devices to communicate with each other. The IEEE 802.11 family of standards has evolved over time to accommodate higher data rates, improved security, and better performance in different environments. Some of the most widely used standards include 802.11a, 802.11b, 802.11g, 802.11n, 802.11ac, and 802.11ax (also known as “Wi-Fi 6”). These standards specify the modulation techniques, channel bandwidths, and other technical aspects that facilitate interoperability between devices from various manufacturers. IEEE 802.11 has played an important role in the widespread adoption of wireless networking in homes, offices, and public spaces, enabling users to connect their devices to the internet and each other without the need for wired connections.

IEEE 802.11be, also known as “Wi-Fi 7”, is the next generation of the IEEE 802.11 family of standards for wireless local area networks. Currently under development, 802.11be aims to significantly improve upon the capabilities of its predecessor, 802.11ax/Wi-Fi 6, by offering even higher data rates, lower latency, and increased reliability. The standard is expected to leverage advanced technologies such as multi-link operation (MLO), which allows devices to simultaneously use multiple frequency bands and channels for enhanced performance and reliability. Additionally, 802.11be will introduce 4096-QAM (Quadrature Amplitude Modulation), enabling higher data rates by encoding more bits per symbol. The standard will also feature improved medium access control (MAC) efficiency, enhanced power saving capabilities, and better support for high-density environments. With these advancements, 802.11be is expected to deliver theoretical maximum data rates of up to 46 gigabits per second (Gbps), making it suitable for bandwidth-intensive applications such as virtual and augmented reality, 8K video streaming, and high-performance gaming.

In legacy IEEE 802.11 wireless networking standards, a wireless device is only allowed to transmit when the primary 20 MHz channel is idle. If the primary 20 MHz channel is busy, a wireless device is not allowed to transmit a physical layer protocol data unit (PPDU) even if the non-primary (secondary) channel(s) is idle. Recent wireless networking standards support wide bandwidths of 320 MHz or more. With such wide bandwidths, leaving idle non-primary channel(s) unused just because the primary 20 MHz channel is busy is seen as inefficient and a waste of channel resources. Non-primary Channel Access (NPCA) is a technology that has been proposed to address this issue. NPCA allows wireless devices to switch to a predesignated non-primary channel and attempt channel access in this non-primary channel when the primary channel is busy.

However, due to varying geographical location and/or differences in components, NPCA-capable wireless devices in a distributed wireless network environment may have varying abilities to receive and decode overlapping basic service set (OBSS) PPDUs (i.e., PPDUs transmitted by OBSSs). A NPCA-capable wireless device that overhears an OBSS PPDU may decide to perform NPCA with another NPCA-capable wireless device during the transmission of the OBSS PPDU, with the assumption that the other NPCA-capable wireless device was also able to overhear and decode the OBSS PPDU. However, in a distributed wireless network environment, this assumption may be incorrect, and result in a failed NPCA attempt.

### BRIEF DESCRIPTION OF THE DRAWINGS

The disclosure will be more fully understood from the detailed description provided below and the accompanying drawings that depict various embodiments of the disclosure. However, these drawings should not be interpreted as limiting the disclosure to the specific embodiments shown; they are provided for explanation and understanding only.

FIG. 1 illustrates an example of a wireless local area network (WLAN) with a basic service set (BSS) that includes multiple wireless devices, in accordance with some embodiments of the present disclosure.

FIG. 2 is a schematic diagram of a wireless device, in accordance with some embodiments of the present disclosure.

FIG. 3A illustrates components of a wireless device configured to transmit data, in accordance with some embodiments of the present disclosure.

FIG. 3B illustrates components of a wireless device configured to receive data, in accordance with some embodiments of the present disclosure.

FIG. 4 illustrates interframe space (IFS) relationships, in accordance with some embodiments of the present disclosure.

FIG. 5 illustrates a Carrier Sense Multiple Access with Collision Avoidance (CSMA/CA)-based frame transmission procedure, in accordance with some embodiments of the present disclosure.

FIG. 6 illustrates maximum physical layer (PHY) rates for Institute of Electrical and Electronics Engineers (IEEE) 802.11 standards, in accordance with some embodiments of the present disclosure.

FIG. 7 provides a detailed description of fields in Extremely High Throughput (EHT) Physical Protocol Data Unit (PPDU) frames, including their purposes and characteristics, in accordance with some embodiments of the present disclosure.

FIG. 8 illustrates an example of multi-user (MU) transmission in Orthogonal Frequency-Division Multiple Access (OFDMA), in accordance with some embodiments of the present disclosure.

FIG. 9 illustrates an example of an access point sending a trigger frame to multiple associated stations and receiving Uplink Orthogonal Frequency-Division Multiple Access Trigger-Based Physical Protocol Data Units (UL OFDMA TB PPDUs) in response, in accordance with some embodiments of the present disclosure.

FIG. 10 is a diagram showing idle secondary channels being unused due to the primary channel being busy, according to some embodiments.

FIG. 11 is a diagram showing the use of non-primary channel access (NPCA) to make use of otherwise idle secondary channels while the primary channel is busy, according to some embodiments.

FIG. 12 is a diagram showing how different APs/STAs (access points and STAs) can have different abilities to receive and decode a physical layer protocol data unit (PPDU) depending on their geographic location, according to some embodiments.

FIG. 13 is a diagram showing an overlapping basic service set (OBSS) information element format, according to some embodiments.

FIG. 14 shows an example OBSS information field format.

FIG. 15 is a diagram showing an action field format, according to some embodiments.

FIG. 16 is a flow diagram showing a method for determining whether to perform NPCA, according to some embodiments.

FIG. 17 is a diagram showing an example network topology, according to some embodiments.

FIG. 18 is a diagram showing how the OBSS information sets of the BSS1 AP/STAs are updated upon overhearing OBSS PPDUs, according to some embodiments.

FIG. 19 is a flow diagram of a method for performing NPCA, according to some embodiments.

FIG. 20 is a diagram showing operations for determining whether the peer wireless device can perform NPCA during transmission of the PPDU, according to some embodiments.

### DETAILED DESCRIPTION

The present disclosure generally relates to wireless communications, and more specifically, relates to maintaining and sharing of an overlapping basic service set (OBSS) information set to support non-primary channel access (NPCA) operations.

This present disclosure describes a solution that can address the situation where NPCA fails due to the difference in decoding abilities among NPCA-capable wireless devices. According to some embodiments, a NPCA-capable wireless device may maintain a local OBSS information set. The local OBSS information set may include information regarding OBSSs that the NPCA-capable wireless device has learned about based on overhearing PPDUs transmitted by the OBSSs. The NPCA-capable wireless devices may also maintain a peer OBSS information set for each of one or more peer wireless devices that belong to the same BSS. The peer OBSS information set for a peer wireless device may include information regarding OBSSs that the peer wireless device has learned about based on overhearing PPDUs transmitted by the OBSSs. For example, the peer OBSS information set for a peer wireless device may include information regarding whether the peer wireless device can obtain NPCA information from preambles transmitted by OBSSs and information regarding the rates or modulation coding schemes receivable by the peer wireless devices from the OBSSs. In an embodiment, the NPCA-capable wireless device shares its local OBSS information set with the one or more peer NPCA-capable wireless devices. If the NPCA-capable wireless device overhears an OBSS PPDU transmitted in a primary channel, the NPCA-capable wireless device may determine, based on the peer OBSS information set for the peer wireless device, whether the peer wireless device can perform NPCA during transmission of the OBSS PPDU. If the NPCA-capable wireless device determines that the peer wireless device can perform NPCA, the NPCA-capable wireless device may perform NPCA with the peer wireless device in a NPCA primary channel.

Embodiments described herein may allow NPCA-capable wireless devices in a distributed environment to independently make the same channel switching decisions for NPCA.

For purposes of illustration, various embodiments are described herein in the context of wireless networks that are based on IEEE 802.11 standards and using terminology and concepts thereof. Those skilled in the art will appreciate that the embodiments disclosed herein can be modified/adapted for use in other types of wireless networks.

In the following detailed description, only certain embodiments of the present invention have been shown and described, simply by way of illustration. As those skilled in the art would realize, the described embodiments may be modified in different ways, all without departing from the spirit or scope of the present invention. Accordingly, the drawings and description are to be regarded as illustrative in nature and not restrictive. Like reference numerals designate like elements throughout the specification.

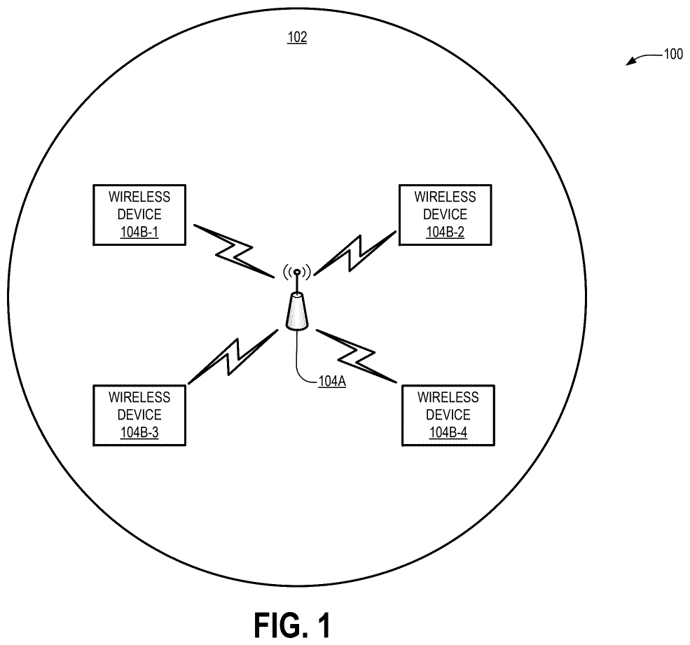

FIG. 1 shows a wireless local area network (WLAN) 100 with a basic service set (BSS) 102 that includes a plurality of wireless devices 104 (sometimes referred to as WLAN devices 104). Each of the wireless devices 104 may include a medium access control (MAC) layer and a physical (PHY) layer according to an IEEE (Institute of Electrical and Electronics Engineers) standard 802.11, including one or more of the amendments (e.g., 802.11a/b/g/n/p/ac/ax/bd/be). In one embodiment, the MAC layer of a wireless device 104 may initiate transmission of a frame to another wireless device 104 by passing a PHY-TXSTART.request (TXVECTOR) to the PHY layer. The TXVECTOR provides parameters for generating and/or transmitting a corresponding frame. Similarly, a PHY layer of a receiving wireless device may generate an RXVECTOR, which includes parameters of a received frame and is passed to a MAC layer for processing.

The plurality of wireless devices 104 may include a wireless device 104A that is an access point (sometimes referred to as an AP station or AP STA) and the other wireless devices 104B₁-104B₄ that are non-AP stations (sometimes referred to as non-AP STAs). Alternatively, all the plurality of wireless devices 104 may be non-AP STAs in an ad-hoc networking environment. In general, the AP STA (e.g., wireless device 104A) and the non-AP STAs (e.g., wireless devices 104B₁-104B₄) may be collectively referred to as STAs. However, for ease of description, only the non-AP STAs may be referred to as STAs unless the context indicates otherwise. Although shown with four non-AP STAs (e.g., the wireless devices 104B₁-104B₄), the WLAN 100 may include any number of non-AP STAs (e.g., one or more wireless devices 104B).

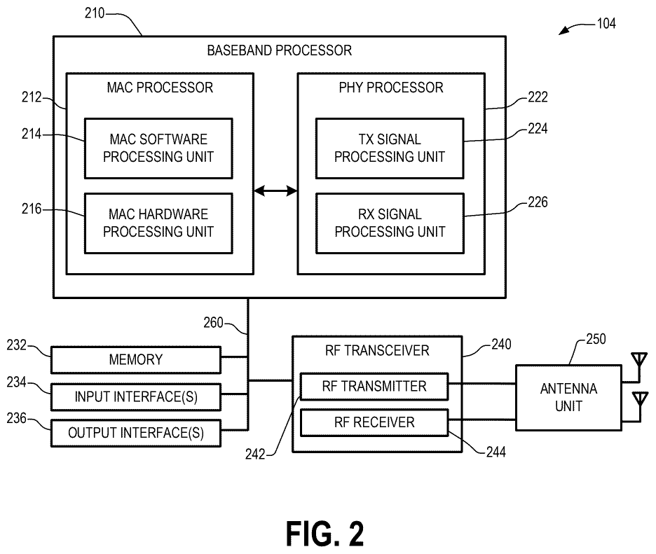

FIG. 2 illustrates a schematic block diagram of a wireless device 104, according to an embodiment. The wireless device 104 may be the wireless device 104A (i.e., the AP of the WLAN 100) or any of the wireless devices 104B₁-104B₄ in FIG. 1. The wireless device 104 includes a baseband processor 210, a radio frequency (RF) transceiver 240, an antenna unit 250, a storage device (e.g., memory device) 232, one or more input interfaces 234, and one or more output interfaces 236. The baseband processor 210, the storage device 232, the input interfaces 234, the output interfaces 236, and the RF transceiver 240 may communicate with each other via a bus 260.

The baseband processor 210 performs baseband signal processing and includes a MAC processor 212 and a PHY processor 222. The baseband processor 210 may utilize the memory 232, which may include a non-transitory computer/machine readable medium having software (e.g., computer/machine programing instructions) and data stored therein.

In an embodiment, the MAC processor 212 includes a MAC software processing unit 214 and a MAC hardware processing unit 216. The MAC software processing unit 214 may implement a first plurality of functions of the MAC layer by executing MAC software, which may be included in the software stored in the storage device 232. The MAC hardware processing unit 216 may implement a second plurality of functions of the MAC layer in special-purpose hardware. However, the MAC processor 212 is not limited thereto. For example, the MAC processor 212 may be configured to perform the first and second plurality of functions entirely in software or entirely in hardware according to an implementation.

The PHY processor 222 includes a transmitting (TX) signal processing unit (SPU) 224 and a receiving (RX) SPU 226. The PHY processor 222 implements a plurality of functions of the PHY layer. These functions may be performed in software, hardware, or a combination thereof according to an implementation.

Functions performed by the transmitting SPU 224 may include one or more of Forward Error Correction (FEC) encoding, stream parsing into one or more spatial streams, diversity encoding of the spatial streams into a plurality of space-time streams, spatial mapping of the space-time streams to transmit chains, inverse Fourier Transform (iFT) computation, Cyclic Prefix (CP) insertion to create a Guard Interval (GI), and the like. Functions performed by the receiving SPU 226 may include inverses of the functions performed by the transmitting SPU 224, such as GI removal, Fourier Transform computation, and the like.

The RF transceiver 240 includes an RF transmitter 242 and an RF receiver 244. The RF transceiver 240 is configured to transmit first information received from the baseband processor 210 to the WLAN 100 (e.g., to another WLAN device 104 of the WLAN 100) and provide second information received from the WLAN 100 (e.g., from another WLAN device 104 of the WLAN 100) to the baseband processor 210.

The antenna unit 250 includes one or more antennas. When Multiple-Input Multiple-Output (MIMO) or Multi-User MIMO (MU-MIMO) is used, the antenna unit 250 may include a plurality of antennas. In an embodiment, the antennas in the antenna unit 250 may operate as a beam-formed antenna array. In an embodiment, the antennas in the antenna unit 250 may be directional antennas, which may be fixed or steerable.

The input interfaces 234 receive information from a user, and the output interfaces 236 output information to the user. The input interfaces 234 may include one or more of a keyboard, keypad, mouse, touchscreen, microphone, and the like. The output interfaces 236 may include one or more of a display device, touch screen, speaker, and the like.

As described herein, many functions of the WLAN device 104 may be implemented in either hardware or software. Which functions are implemented in software and which functions are implemented in hardware will vary according to constraints imposed on a design. The constraints may include one or more of design cost, manufacturing cost, time to market, power consumption, available semiconductor technology, etc.

As described herein, a wide variety of electronic devices, circuits, firmware, software, and combinations thereof may be used to implement the functions of the components of the WLAN device 104. Furthermore, the WLAN device 104 may include other components, such as application processors, storage interfaces, clock generator circuits, power supply circuits, and the like, which have been omitted in the interest of brevity.

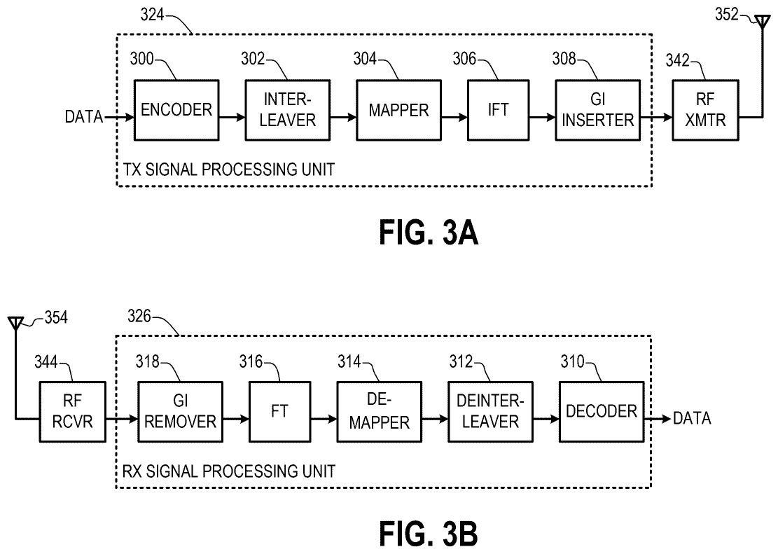

FIG. 3A illustrates components of a WLAN device 104 configured to transmit data according to an embodiment, including a transmitting (Tx) SPU (TxSP) 324, an RF transmitter 342, and an antenna 352. In an embodiment, the TxSP 324, the RF transmitter 342, and the antenna 352 correspond to the transmitting SPU 224, the RF transmitter 242, and an antenna of the antenna unit 250 of FIG. 2, respectively.

The TxSP 324 includes an encoder 300, an interleaver 302, a mapper 304, an inverse Fourier transformer (IFT) 306, and a guard interval (GI) inserter 308.

The encoder 300 receives and encodes input data. In an embodiment, the encoder 300 includes a forward error correction (FEC) encoder. The FEC encoder may include a binary convolution code (BCC) encoder followed by a puncturing device. The FEC encoder may include a low-density parity-check (LDPC) encoder.

The TxSP 324 may further include a scrambler for scrambling the input data before the encoding is performed by the encoder 300 to reduce the probability of long sequences of Os or Is. When the encoder 300 performs the BCC encoding, the TxSP 324 may further include an encoder parser for demultiplexing the scrambled bits among a plurality of BCC encoders. If LDPC encoding is used in the encoder, the TxSP 324 may not use the encoder parser.

The interleaver 302 interleaves the bits of each stream output from the encoder 300 to change an order of bits therein. The interleaver 302 may apply the interleaving only when the encoder 300 performs BCC encoding and otherwise may output the stream output from the encoder 300 without changing the order of the bits therein.

The mapper 304 maps the sequence of bits output from the interleaver 302 to constellation points. If the encoder 300 performed LDPC encoding, the mapper 304 may also perform LDPC tone mapping in addition to constellation mapping.

When the TxSP 324 performs a MIMO or MU-MIMO transmission, the TxSP 324 may include a plurality of interleavers 302 and a plurality of mappers 304 according to a number of spatial streams (NSS) of the transmission. The TxSP 324 may further include a stream parser for dividing the output of the encoder 300 into blocks and may respectively send the blocks to different interleavers 302 or mappers 304. The TxSP 324 may further include a space-time block code (STBC) encoder for spreading the constellation points from the spatial streams into a number of space-time streams (NSTS) and a spatial mapper for mapping the space-time streams to transmit chains. The spatial mapper may use direct mapping, spatial expansion, or beamforming.

The IFT 306 converts a block of the constellation points output from the mapper 304 (or, when MIMO or MU-MIMO is performed, the spatial mapper) to a time domain block (i.e., a symbol) by using an inverse discrete Fourier transform (IDFT) or an inverse fast Fourier transform (IFFT). If the STBC encoder and the spatial mapper are used, the IFT 306 may be provided for each transmit chain.

When the TxSP 324 performs a MIMO or MU-MIMO transmission, the TxSP 324 may insert cyclic shift diversities (CSDs) to prevent unintentional beamforming. The TxSP 324 may perform the insertion of the CSD before or after the IFT 306. The CSD may be specified per transmit chain or may be specified per space-time stream. Alternatively, the CSD may be applied as a part of the spatial mapper.

When the TxSP 324 performs a MIMO or MU-MIMO transmission, some blocks before the spatial mapper may be provided for each user.

The GI inserter 308 prepends a GI to each symbol produced by the IFT 306. Each GI may include a Cyclic Prefix (CP) corresponding to a repeated portion of the end of the symbol that the GI precedes. The TxSP 324 may optionally perform windowing to smooth edges of each symbol after inserting the GI.

The RF transmitter 342 converts the symbols into an RF signal and transmits the RF signal via the antenna 352. When the TxSP 324 performs a MIMO or MU-MIMO transmission, the GI inserter 308 and the RF transmitter 342 may be provided for each transmit chain.

FIG. 3B illustrates components of a WLAN device 104 configured to receive data according to an embodiment, including a Receiver (Rx) SPU (RxSP) 326, an RF receiver 344, and an antenna 354. In an embodiment, the RxSP 326, RF receiver 344, and antenna 354 may correspond to the receiving SPU 226, the RF receiver 244, and an antenna of the antenna unit 250 of FIG. 2, respectively.

The RxSP 326 includes a GI remover 318, a Fourier transformer (FT) 316, a demapper 314, a deinterleaver 312, and a decoder 310.

The RF receiver 344 receives an RF signal via the antenna 354 and converts the RF signal into symbols. The GI remover 318 removes the GI from each of the symbols. When the received transmission is a MIMO or MU-MIMO transmission, the RF receiver 344 and the GI remover 318 may be provided for each receive chain.

The FT 316 converts each symbol (that is, each time domain block) into a frequency domain block of constellation points by using a discrete Fourier transform (DFT) or a fast Fourier transform (FFT). The FT 316 may be provided for each receive chain.

When the received transmission is the MIMO or MU-MIMO transmission, the RxSP 326 may include a spatial demapper for converting the respective outputs of the FTs 316 of the receiver chains to constellation points of a plurality of space-time streams, and an STBC decoder for despreading the constellation points from the space-time streams into one or more spatial streams.

The demapper 314 demaps the constellation points output from the FT 316 or the STBC decoder to bit streams. If the received transmission was encoded using LDPC encoding, the demapper 314 may further perform LDPC tone demapping before performing the constellation demapping.

The deinterleaver 312 deinterleaves the bits of each stream output from the demapper 314. The deinterleaver 312 may perform the deinterleaving only when the received transmission was encoded using BCC encoding, and otherwise may output the stream output by the demapper 314 without performing deinterleaving.

When the received transmission is the MIMO or MU-MIMO transmission, the RxSP 326 may use a plurality of demappers 314 and a plurality of deinterleavers 312 corresponding to the number of spatial streams of the transmission. In this case, the RxSP 326 may further include a stream deparser for combining the streams output from the deinterleavers 312.

The decoder 310 decodes the streams output from the deinterleaver 312 or the stream deparser. In an embodiment, the decoder 310 includes an FEC decoder. The FEC decoder may include a BCC decoder or an LDPC decoder.

The RxSP 326 may further include a descrambler for descrambling the decoded data. When the decoder 310 performs BCC decoding, the RxSP 326 may further include an encoder deparser for multiplexing the data decoded by a plurality of BCC decoders. When the decoder 310 performs the LDPC decoding, the RxSP 326 may not use the encoder deparser.

Before making a transmission, wireless devices such as wireless device 104 will assess the availability of the wireless medium using Clear Channel Assessment (CCA). If the medium is occupied, CCA may determine that it is busy, while if the medium is available, CCA determines that it is idle.

The PHY entity for IEEE 802.11 is based on Orthogonal Frequency Division Multiplexing (OFDM) or Orthogonal Frequency Division Multiple Access (OFDMA). In either OFDM or OFDMA Physical (PHY) layers, a STA (e.g., a wireless device 104) is capable of transmitting and receiving Physical Layer (PHY) Protocol Data Units (PPDUs) (also referred to as PLCP (Physical Layer Convergence Procedure) Protocol Data Units) that are compliant with the mandatory PHY specifications. A PHY specification defines a set of Modulation and Coding Schemes (MCS) and a maximum number of spatial streams. Some PHY entities define downlink (DL) and uplink (UL) Multi-User (MU) transmissions having a maximum number of space-time streams (STS) per user and employing up to a predetermined total number of STSs. A PHY entity may provide support for 10 Megahertz (MHz), 20 MHz, 40 MHz, 80 MHz, 160 MHz, 240 MHz, and 320 MHz contiguous channel widths and support for an 80+80, 80+160 MHz, and 160+160 MHz non-contiguous channel width. Each channel includes a plurality of subcarriers, which may also be referred to as tones. A PHY entity may define signaling fields denoted as Legacy Signal (L-SIG), Signal A (SIG-A), and Signal B (SIG-B), and the like within a PPDU by which some necessary information about PHY Service Data Unit (PSDU) attributes are communicated. The descriptions below, for sake of completeness and brevity, refer to OFDM-based 802.11 technology. Unless otherwise indicated, a station refers to a non-AP STA.

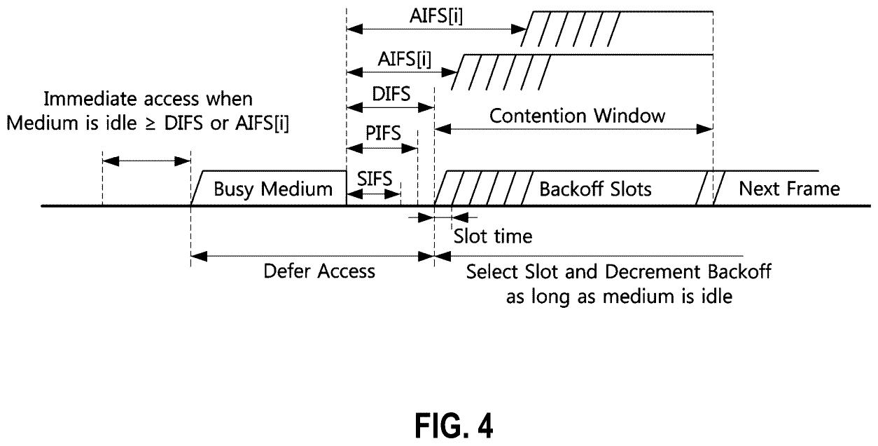

FIG. 4 illustrates Inter-Frame Space (IFS) relationships. In particular, FIG. 4 illustrates a Short IFS (SIFS), a Point Coordination Function (PCF) IFS (PIFS), a Distributed Coordination Function (DCF) IFS (DIFS), and an Arbitration IFSs corresponding to an Access Category (AC) ‘i’ (AIFS[i]). FIG. 4 also illustrates a slot time and a data frame is used for transmission of data forwarded to a higher layer. As shown, a WLAN device 104 transmits the data frame after performing backoff if a DIFS has elapsed during which the medium has been idle.

A management frame may be used for exchanging management information, which is not forwarded to the higher layer. Subtype frames of the management frame include a beacon frame, an association request/response frame, a probe request/response frame, and an authentication request/response frame.

A control frame may be used for controlling access to the medium. Subtype frames of the control frame include a request to send (RTS) frame, a clear to send (CTS) frame, and an acknowledgement (ACK) frame.

When the control frame is not a response frame of another frame, the WLAN device 104 transmits the control frame after performing backoff if a DIFS has elapsed during which the medium has been idle. When the control frame is the response frame of another frame, the WLAN device 104 transmits the control frame after a SIFS has elapsed without performing backoff or checking whether the medium is idle.

A WLAN device 104 that supports Quality of Service (QoS) functionality (that is, a QoS STA) may transmit the frame after performing backoff if an AIFS for an associated access category (AC) (i.e., AIFS[AC]) has elapsed. When transmitted by the QoS STA, any of the data frame, the management frame, and the control frame, which is not the response frame, may use the AIFS[AC] of the AC of the transmitted frame.

A WLAN device 104 may perform a backoff procedure when the WLAN device 104 that is ready to transfer a frame finds the medium busy. The backoff procedure includes determining a random backoff time composed of N backoff slots, where each backoff slot has a duration equal to a slot time and N being an integer number greater than or equal to zero. The backoff time may be determined according to a length of a Contention Window (CW). In an embodiment, the backoff time may be determined according to an AC of the frame. All backoff slots occur following a DIFS or Extended IFS (EIFS) period during which the medium is determined to be idle for the duration of the period.

When the WLAN device 104 detects no medium activity for the duration of a particular backoff slot, the backoff procedure shall decrement the backoff time by the slot time. When the WLAN device 104 determines that the medium is busy during a backoff slot, the backoff procedure is suspended until the medium is again determined to be idle for the duration of a DIFS or EIFS period. The WLAN device 104 may perform transmission or retransmission of the frame when the backoff timer reaches zero.

The backoff procedure operates so that when multiple WLAN devices 104 are deferring and execute the backoff procedure, each WLAN device 104 may select a backoff time using a random function and the WLAN device 104 that selects the smallest backoff time may win the contention, reducing the probability of a collision.

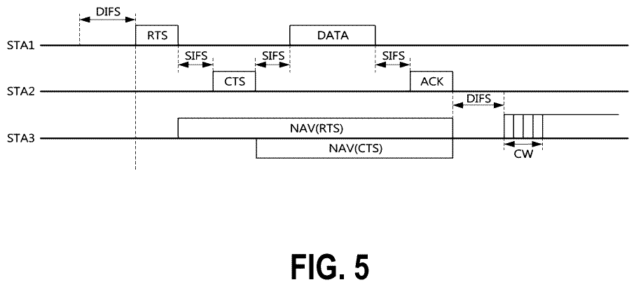

FIG. 5 illustrates a Carrier Sense Multiple Access/Collision Avoidance (CSMA/CA) based frame transmission procedure for avoiding collision between frames in a channel according to an embodiment. FIG. 5 shows a first station STA1 transmitting data, a second station STA2 receiving the data, and a third station STA3 that may be located in an area where a frame transmitted from the STA1 can be received, a frame transmitted from the second station STA2 can be received, or both can be received. The stations STA1, STA2, and STA3 may be WLAN devices 104 of FIG. 1.

The station STA1 may determine whether the channel is busy by carrier sensing. The station STA1 may determine channel occupation/status based on an energy level in the channel or an autocorrelation of signals in the channel, or may determine the channel occupation by using a network allocation vector (NAV) timer.

After determining that the channel is not used by other devices (that is, that the channel is IDLE) during a DIFS (and performing backoff if required), the station STA1 may transmit a Request-To-Send (RTS) frame to the station STA2. Upon receiving the RTS frame, after a SIFS the station STA2 may transmit a Clear-To-Send (CTS) frame as a response to the RTS frame. If Dual-CTS is enabled and the station STA2 is an AP, the AP may send two CTS frames in response to the RTS frame (e.g., a first CTS frame in a non-High Throughput format and a second CTS frame in the HT format).

When the station STA3 receives the RTS frame, it may set a NAV timer of the station STA3 for a transmission duration of subsequently transmitted frames (for example, a duration of SIFS+CTS frame duration+SIFS+data frame duration+SIFS+ACK frame duration) using duration information included in the RTS frame. When the station STA3 receives the CTS frame, it may set the NAV timer of the station STA3 for a transmission duration of subsequently transmitted frames using duration information included in the CTS frame. Upon receiving a new frame before the NAV timer expires, the station STA3 may update the NAV timer of the station STA3 by using duration information included in the new frame. The station STA3 does not attempt to access the channel until the NAV timer expires.

When the station STA1 receives the CTS frame from the station STA2, it may transmit a data frame to the station STA2 after a SIFS period elapses from a time when the CTS frame has been completely received. Upon successfully receiving the data frame, the station STA2 may transmit an ACK frame as a response to the data frame after a SIFS period elapses.

When the NAV timer expires, the third station STA3 may determine whether the channel is busy using the carrier sensing. Upon determining that the channel is not used by other devices during a DIFS period after the NAV timer has expired, the station STA3 may attempt to access the channel after a contention window elapses according to a backoff process.

When Dual-CTS is enabled, a station that has obtained a transmission opportunity (TXOP) and that has no data to transmit may transmit a CF-End frame to cut short the TXOP. An AP receiving a CF-End frame having a Basic Service Set Identifier (BSSID) of the AP as a destination address may respond by transmitting two more CF-End frames: a first CF-End frame using Space Time Block Coding (STBC) and a second CF-End frame using non-STBC. A station receiving a CF-End frame resets its NAV timer to 0 at the end of the PPDU containing the CF-End frame. FIG. 5 shows the station STA2 transmitting an ACK frame to acknowledge the successful reception of a frame by the recipient.

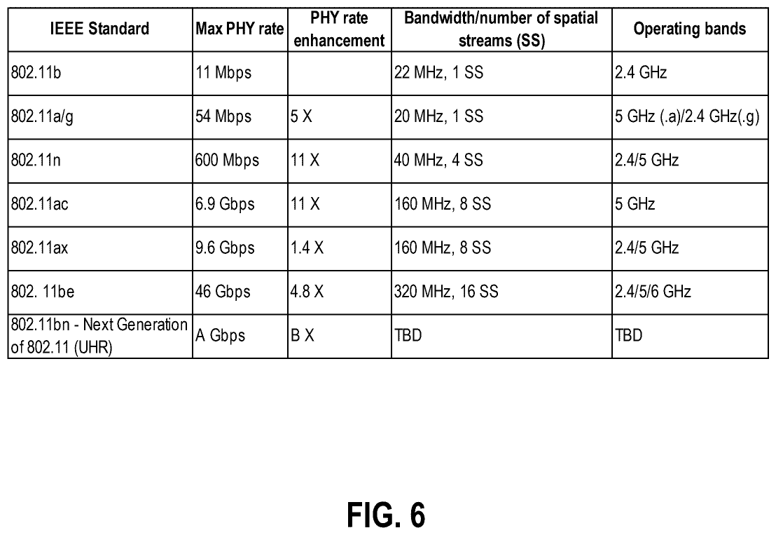

The IEEE 802.11bn (Ultra High Reliability, UHR) working group has been established to address the growing demand for higher peak throughput and reliability in Wi-Fi. As shown in FIG. 6, the peak PHY rate has significantly increased from IEEE 802.11b to IEEE 802.11be (Wi-Fi 7), with the latter focusing on further improving peak throughput. The UHR study group aims to enhance the tail of the latency distribution and jitter to support applications that require low latency, such as video-over-WLAN, gaming, AR, and VR. It is noted that various characteristics of UHR (e.g., max PHY rate, PHY rate enhancement, bandwidth/number of spatial streams, and operating bands) are still to be determined.

The focus of IEEE 802.11be is primarily on WLAN indoor and outdoor operation with stationary and pedestrian speeds in the 2.4, 5, and 6 GHz frequency bands. In addition to peak PHY rate, different candidate features are under discussion. These candidate features include (1) a 320 MHz bandwidth and a more efficient utilization of a non-contiguous spectrum, (2) multi-band/multi-channel aggregation and operation, (3) 16 spatial streams and Multiple Input Multiple Output (MIMO) protocol enhancements, (4) multi-Access Point (AP) Coordination (e.g., coordinated and joint transmission), (5) an enhanced link adaptation and retransmission protocol (e.g., Hybrid Automatic Repeat Request (HARQ)), and (6) adaptation to regulatory rules specific to a 6 GHz spectrum.

The focus of IEEE 802.11bn (UHR) is still under discussion, with candidate features including MLO enhancements (e.g., in terms of increased throughput/reliability and decreased latency), latency and reliability improvements (e.g., multi-AP coordination to support low latency traffic), bandwidth expansion (e.g., to 240, 480, 640 MHz), aggregated PPDU (A-PPDU), enhanced multi-link single-radio (eMLSR) extensions to AP, roaming improvements, and power-saving schemes for prolonging battery life.

Some features, such as increasing the bandwidth and the number of spatial streams, are solutions that have been proven to be effective in previous projects focused on increasing link throughput and on which feasibility demonstration is achievable.

With respect to operational bands (e.g., 2.4/5/6 GHz) for IEEE 802.11be, more than 1 GHz of additional unlicensed spectrum is likely to be available because the 6 GHz band (5.925-7.125 GHz) is being considered for unlicensed use. This would allow APs and STAs to become tri-band devices. Larger than 160 MHz data transmissions (e.g., 320 MHz or 640 MHz) could be considered to increase the maximum PHY rate. For example, 320 MHz or 160+160 MHz data could be transmitted in the 6 GHz band. For example, 160+160 MHz data could be transmitted across the 5 and 6 GHz bands.

In the process of wireless communication, a transmitting station (STA) creates a Physical Layer Protocol Data Unit (PPDU) frame and sends it to a receiving STA. The receiving STA then receives, detects, and processes the PPDU.

The Extremely High Throughput (EHT) PPDU frame encompasses several components. It includes a legacy part, which comprises fields such as the Legacy Short Training Field (L-STF), Legacy Long Training Field (L-LTF), Legacy Signal Field (L-SIG), and Repeated Legacy Signal Field (RL-SIG). These fields are used to maintain compatibility with older Wi-Fi standards.

In addition to the legacy part, the EHT PPDU frame also contains the Universal Signal Field (U-SIG), EHT Signal Field (EHT-SIG), EHT Short Training Field (EHT-STF), and EHT Long Training Field (EHT-LTF). These fields are specific to the EHT standard and are used for various purposes, such as signaling, synchronization, and channel estimation.

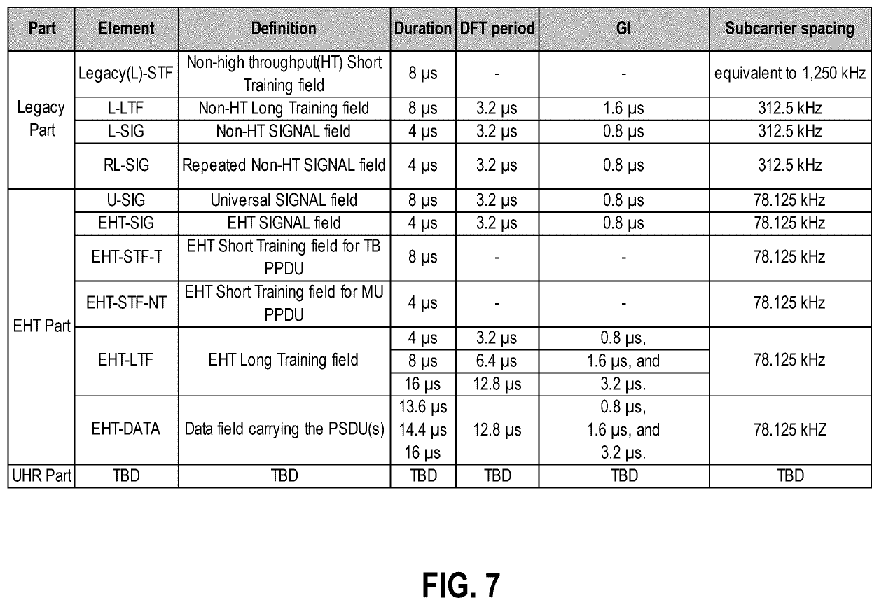

FIG. 7 provides a more detailed description of each field in the EHT PPDU frame, including their purposes and characteristics.

Regarding the Ultra High Reliability (UHR) PPDU, its frame structure is currently undefined and will be determined through further discussions within the relevant working group or study group. This indicates that the specifics of the UHR PPDU are still under development and will be finalized based on the outcomes of future deliberations.

The distributed nature of channel access networks, such as IEEE 802.11 WLANs, makes the carrier sense mechanism useful for ensuring collision-free operation. Each station (STA) uses its physical carrier sense to detect transmissions from other STAs. However, in certain situations, it may not be possible for a STA to detect every transmission. For instance, when one STA is located far away from another STA, it might perceive the medium as idle and start transmitting a frame, leading to collisions. To mitigate this hidden node problem, the network allocation vector (NAV) has been introduced.

As the IEEE 802.11 standard continues to evolve, it now includes scenarios where multiple users can simultaneously transmit or receive data within a basic service set (BSS), such as uplink (UL) and downlink (DL) multi-user (MU) transmissions in a cascaded manner. In these cases, the existing carrier sense and NAV mechanisms may not be sufficient, and modifications or newly defined mechanisms may be required to facilitate efficient and collision-free operation.

For the purpose of this disclosure, MU transmission refers to situations where multiple frames are transmitted to or from multiple STAs simultaneously using different resources. Examples of these resources include different frequency resources in Orthogonal Frequency Division Multiple Access (OFDMA) transmission and different spatial streams in Multi-User Multiple Input Multiple Output (MU-MIMO) transmission. Consequently, downlink OFDMA (DL-OFDMA), downlink MU-MIMO (DL-MU-MIMO), uplink OFDMA (UL-OFDMA), uplink MU-MIMO (UL-MU-MIMO), and OFDMA with MU-MIMO are all considered examples of MU transmission.

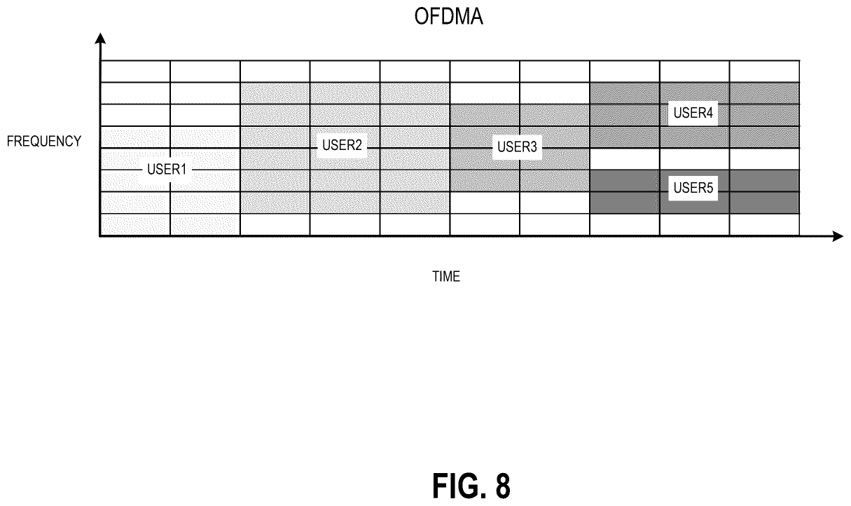

FIG. 8 illustrates an example of multi-user (MU) transmission in Orthogonal Frequency-Division Multiple Access (OFDMA), in accordance with some embodiments of the present disclosure.

In the IEEE 802.11ax and 802.11be specifications, the trigger frame plays a useful role in facilitating uplink multi-user (MU) transmissions. The purpose of the trigger frame is to allocate resources and solicit one or more Trigger-based (TB) Physical Layer Protocol Data Unit (PPDU) transmissions from the associated stations (STAs).

The trigger frame contains information required by the responding STAs to send their Uplink TB PPDUs. This information includes the Trigger type, which specifies the type of TB PPDU expected, and the Uplink Length (UL Length), which indicates the duration of the uplink transmission.

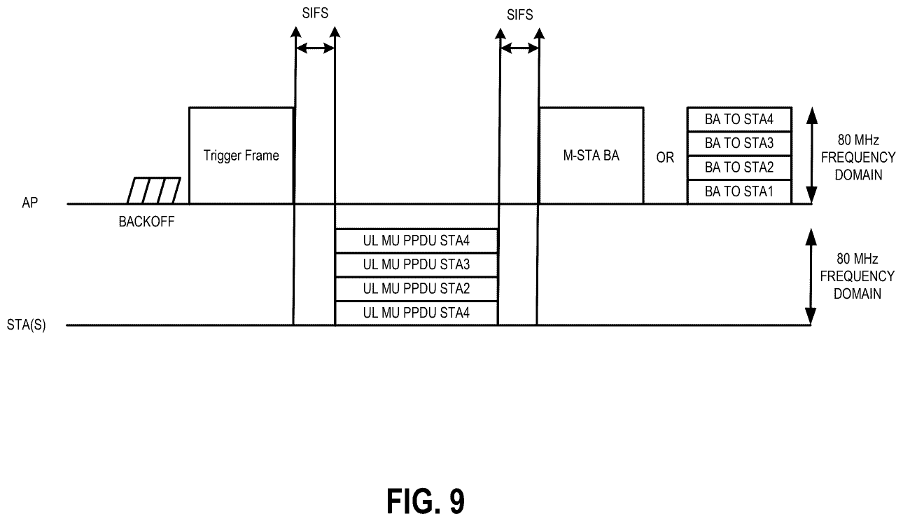

FIG. 9 illustrates an example scenario where an access point (AP) operating in an 80 MHz bandwidth environment sends a Trigger frame to multiple associated STAs. Upon receiving the Trigger frame, the STAs respond by sending their respective Uplink Orthogonal Frequency Division Multiple Access (UL OFDMA) TB PPDUs, utilizing the allocated resources within the specified 80 MHz bandwidth.

After successfully receiving the UL OFDMA TB PPDUs, the AP acknowledges the STAs by sending an acknowledgement frame. This acknowledgement can be in the form of an 80 MHz width multi-STA Block Acknowledgement (Block Ack) or a Block Acknowledgement with a Direct Feedback (DF) OFDMA method. The multi-STA Block Ack allows the AP to acknowledge multiple STAs simultaneously, while the Block Ack with DF OFDMA enables the AP to provide feedback to the STAs using the same OFDMA technique employed in the uplink transmission.

The trigger frame is a useful component in enabling efficient uplink MU transmissions in IEEE 802.11ax and 802.11be networks, by allocating resources and coordinating the uplink transmissions from multiple STAs within the same bandwidth.

Wireless network systems can rely on retransmission of media access control (MAC) protocol data units (MPDUs) when the transmitter (TX) does not receive an acknowledgement from the receiver (RX) or MPDUs are not successfully decoded by the receiver. Using an automatic repeat request (ARQ) approach, the receiver discards the last failed MPDU before receiving the newly retransmitted MPDU. With requirements of enhanced reliability and reduced latency, the wireless network system can evolve toward a hybrid ARQ (HARQ) approach.

There are two methods of HARQ processing. In a first type of HARQ scheme, also referred to as chase combining (CC) HARQ (CC-HARQ) scheme, signals to be retransmitted are the same as the signals that previously failed because all subpackets to be retransmitted use the same puncturing pattern. The puncturing is needed to remove some of the parity bits after encoding using an error-correction code. The reason why the same puncturing pattern is used with CC-HARQ is to generate a coded data sequence with forward error correction (FEC) and to make the receiver use a maximum-ratio combining (MRC) to combine the received, retransmitted bits with the same bits from the previous transmission. For example, information sequences are transmitted in packets with a fixed length. At a receiver, error correction and detection are carried out over the whole packet. However, the ARQ scheme may be inefficient in the presence of burst errors. To solve this more efficiently, subpackets are used. In subpacket transmissions, only those subpackets that include errors need to be retransmitted.

Since the receiver uses both the current and the previously received subpackets for decoding data, the error probability in decoding decreases as the number of used subpackets increases. The decoding process passes a cyclic redundancy check (CRC) and ends when the entire packet is decoded without error or the maximum number of subpackets is reached. In particular, this scheme operates on a stop-and-wait protocol such that if the receiver can decode the packet, it sends an acknowledgement (ACK) to the transmitter. When the transmitter receives an ACK successfully, it terminates the HARQ transmission of the packet. If the receiver cannot decode the packet, it sends a negative acknowledgement (NAK) to the transmitter and the transmitter performs the retransmission process.

In a second type of HARQ scheme, also referred to as an incremental redundancy (IR) HARQ (IR-HARQ) scheme, different puncturing patterns are used for each subpacket such that the signal changes for each retransmitted subpacket in comparison to the originally transmitted subpacket. IR-HARQ alternatively uses two puncturing patterns for odd numbered and even numbered transmissions, respectively. The redundancy scheme of IR-HARQ improves the log likelihood ratio (LLR) of parity bit(s) in order to combine information sent across different transmissions due to requests and lowers the code rate as the additional subpacket is used. This results in a lower error rate of the subpacket in comparison to CC-HARQ. The puncturing pattern used in IR-HARQ is indicated by a subpacket identity (SPID) indication. The SPID of the first subpacket may always be set to 0 and all the systematic bits and the punctured parity bits are transmitted in the first subpacket. Self-decoding is possible when the receiving signal-to-noise ratio (SNR) environment is good (i.e., a high SNR). In some embodiments, subpackets with corresponding SPIDs to be transmitted are in increasing order of SPID but can be exchanged/switched except for the first SPID.

AP coordination has been considered as a potential technology to improve WLAN system throughput in the IEEE 802.11be standard and is still being discussed in the IEEE 802.11bn (UHR) standard. To support various AP coordination schemes, such as coordinated beamforming, OFDMA, TDMA, spatial reuse, and joint transmission, a predefined mechanism for APs is necessary.

In the context of coordinated TDMA (C-TDMA), the AP that obtains a transmit opportunity (TXOP) is referred to as the sharing AP. This AP initiates the AP coordination schemes to determine the AP candidate set by sending a frame, such as a Beacon frame or probe response frame, which includes information about the AP coordination scheme capabilities. The AP that participates in the AP coordination schemes after receiving the frame from the sharing AP is called the shared AP. The sharing AP is also known as the master AP or coordinating AP, while the shared AP is referred to as the slave AP or coordinated AP.

The operation of various AP coordination schemes has been discussed in the IEEE 802.11be and UHR standards:

Coordinated Beamforming (C-BF): Multiple APs transmit on the same frequency resource by coordinating and forming spatial nulls, allowing for simultaneous transmission from multiple APs.

Coordinated OFDMA (C-OFDMA): APs transmit on orthogonal frequency resources by coordinating and splitting the spectrum, enabling more efficient spectrum utilization.

Joint Transmission (JTX): Multiple APs transmit jointly to a given user simultaneously by sharing data between the APs.

Coordinated Spatial Reuse (C-SR): Multiple APs or STAs adjust their transmit power to reduce interference between APs.

By implementing these AP coordination schemes, WLAN systems can improve their overall throughput and efficiency by leveraging the cooperation between multiple APs.

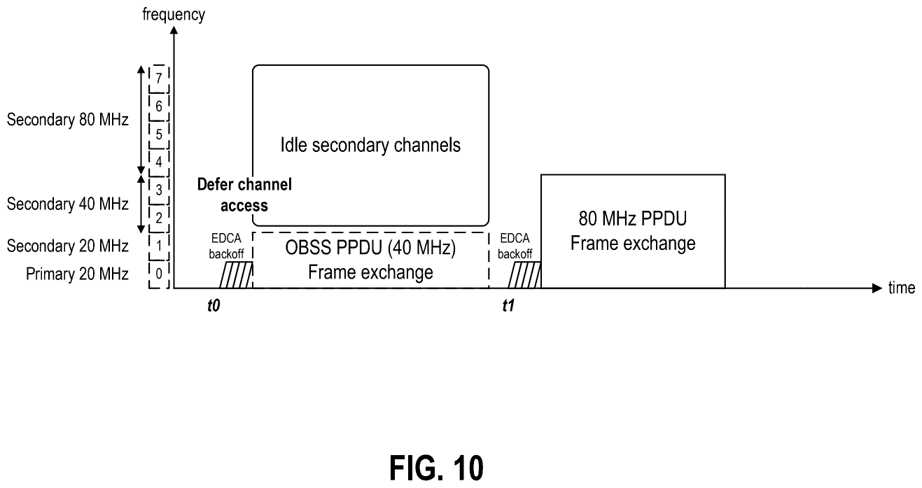

In legacy IEEE 802.11 wireless networking standards, transmission is only allowed when the primary 20 MHz channel is idle. This is to ensure that multiple contending wireless devices attempt channel access in the same channel, providing all wireless devices with equal opportunities to access the channel. However, as wireless device performance and capabilities have advanced, the available operating bandwidth has increased, with recent wireless devices supporting up to 320 MHz operating bandwidths. With the increase in operating bandwidths, only allowing transmission when the primary 20 MHz channel is idle can be seen as inefficient and as a waste of channel resources. FIG. 10 is a diagram illustrating this inefficiency.

FIG. 10 is a diagram showing idle secondary channels being unused due to the primary channel being busy, according to some embodiments.

The diagram shows an example where the operating bandwidth is 160 MHz. The 160 MHz operating bandwidth may include a primary 20 MHz channel (channel #0), a secondary 20 MHz channel (channel #1), a secondary 40 MHz channel (composed of channels #2 and #3), and a secondary 80 MHz channel (composed of channels #4, #5, #6, and #7).

It is assumed in this example that there is a first BSS that includes NPCA-capable AP/STAs (the first BSS may be referred to as “MyBSS”) and a second BSS that overlaps with the first BSS (the second BSS may be referred to as an “OBSS” with respect to MyBSS).

In the example shown in the diagram, after performing a backoff procedure at time t0, the OBSS occupies a 40 MHz band that includes the primary 20 MHz channel and the secondary 20 MHz channel (OBSS PPDU exchange). In such a scenario, NPCA-capable STAs that belong to MyBSS (referred to herein as MyBSS STAs) may attempt to access the channel at t0 (or shortly thereafter) but may be unable to access the channel due to the OBSS PPDU exchange occupying the primary 20 MHz channel. The MyBSS STAs may be unable to access the channel until time t1 even though the secondary channels (e.g., the secondary 40 MHz channel and the secondary 80 MHz channel) are idle during the OBSS PPDU exchange. Thus, the MyBSS STAs have to wait (defer channel access) until after time t1 to perform a PPDU exchange (e.g., 80 MHz PPDU exchange) in MyBSS.

Leaving the idle non-primary (secondary) channels unused just because the primary 20 MHz channel is busy is a waste of channel resources. The use of NPCA may help better utilize the idle channel resources and improve overall network performance and latency. As mentioned earlier, the use of NPCA may enhance network efficiency by allowing NPCA-capable wireless devices to switch to a predefined non-primary (secondary) channel when the primary 20 MHz channel is busy.

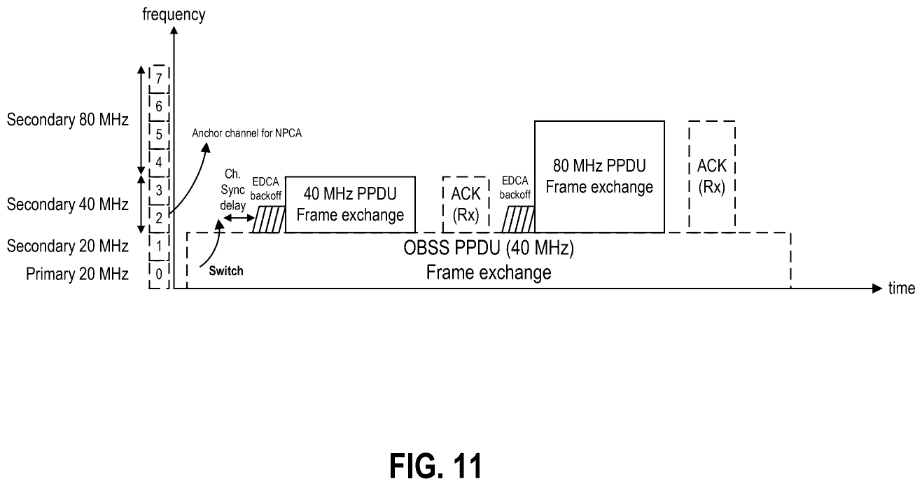

FIG. 11 is a diagram showing the use of NPCA to make use of otherwise idle secondary channels while the primary channel is busy, according to some embodiments.

The diagram illustrates how the use of NPCA technology can improve network efficiency/utilization. As shown in the diagram, an OBSS PPDU exchange may occupy the primary 20 MHz channel and the secondary 20 MHz channel for a period of time. NPCA-capable MyBSS STAs that detect the OBSS PPDU exchange may switch to a predesignated anchor channel (e.g., the NPCA primary channel, which in this example is channel #2) among the secondary channels. The NPCA-capable MyBSS STAs may perform a backoff procedure in the predesignated anchor channel just as they would in the primary channel and then perform a PPDU exchange in the idle secondary channel(s) including the anchor channel. For example, the NPCA-capable MyBSS STAs may perform a 40 MHz PPDU exchange in the secondary 40 MHz channel and perform a 80 MHz PPDU exchange in the secondary 40 MHz channel and the lower 40 MHz of the secondary 80 MHz channel during the period of time that the OBSS PPDU exchange occupies the primary 20 MHz channel.

A NPCA-capable STA may decode a received OBSS PPDU to obtain information regarding the OBSS that transmitted the PPDU and to determine how long the OBSS will occupy the primary channel. Such information can be found in: 1) the PHY preamble; and/or 2) certain fields included in the MAC protocol data unit (MPDU). For example, in the case of IEEE 802.11 HE/EHT/UHR and subsequent wireless networking standards, the relevant information needed for performing NPCA may be obtained from the TXOP_DURATION field and BSS_COLOR field of the PHY preamble. As another example, the relevant information needed for performing NPCA may be obtained from the address field, BSSID field, and/or duration/ID field. The information needed for performing NPCA may be referred to herein as NPCA information. NPCA information may include information for determining whether an overheard PPDU is an OBSS PPDU or not (e.g., OBSS ID/color information) and information for determining how long an OBSS will occupy the primary channel (e.g., the OBSS channel occupancy duration, which can be inferred from the NAV duration or TXOP duration).

Even if a NPCA-capable STA overhears an OBSS PPDU and is able to obtain NPCA information from the OBSS PPDU, it does not necessarily need to perform NPCA for every OBSS PPDU it overhears. The NPCA-capable STA may first establish an agreement regarding NPCA operations with its associated AP. Once such an agreement is in place, each NPCA-capable AP/STA may independently determine whether to perform channel switching for NPCA in a distributed manner.

Decisions regarding whether to switch channels for NPCA operations may require knowing additional information beyond knowing the OBSS channel occupancy duration. In this regard, each NPCA-capable AP/STA may maintain an OBSS information set that it can reference when making channel switching decisions for NPCA. The OBSS information set may include information regarding OBSSs that the NPCA-capable STA has learned about based on overhearing OBSS PPDUs (PPDUs transmitted by OBSSs). The NPCA-capable AP/STA may compare the information obtained from an overheard and decoded OBSS PPDU with the information in its OBSS information set to decide whether it should switch channels to perform NPCA. The OBSS information set may be organized/structured in any suitable format. In the present disclosure, the OBSS information set is shown as being organized/structured in a table format (with rows and columns). However, it should be appreciated that an OBSS information set can be organized/structured in a different format (e.g., as a list).

For the sake of simplifying the explanation, it is assumed that the OBSS information set is maintained/updated based on information obtained from downlink (DL) PPDUs transmitted by OBSS APs. It will be appreciated, however, that the OBSS information set can also be maintained/updated based on information obtained from uplink (UL) PPDUs transmitted by OBSS non-AP STAs. Table 1 shows an example of an OBSS information set that can be maintained based on information obtained from OBSS PPDUs. As shown in Table 1, The OBSS information set may include the ID of the OBSS (e.g., BSS color or OBSSID) or the ID of the AP that operates the OBSS, the operating bandwidth of the OBSS, the primary 20 MHz channel number for the OBSS, and potentially other information. Maintaining this information allows a NPCA-capable AP/STA to determine whether NPCA can be performed when overhearing PPDUs transmitted by the OBSSs listed in the OBSS information set.

In an embodiment, a NPCA-capable AP/STA only performs NPCA if the overheard OBSS PPDU is transmitted by an OBSS listed in its OBSS information set. While it is possible to decode an arbitrary OBSS PPDU transmitted by an OBSS that is not listed in the OBSS information set and to perform NPCA during the NAV duration indicated in the OBSS PPDU (primary channel occupancy duration), this may cause the issue of not knowing whether the peer STAs will also perform NPCA. As such, it may be important to maintain an OBSS information set.

TABLE 1

| | | | |
|---|---|---|---|
| OBSS information | | | |
| (BSS | Operating | Primary channel | Other |
| Color/OBSSID) | Bandwidth | number | information |

| | | |
|---|---|---|
| BSS2 | 320 MHz | 55 |
| BSS6 | 160 MHz | 61 |

An AP and its associated STAs may exchange their OBSS information sets with each other. In an embodiment, the information can be included in management frames such as probe request/response frames and/or action frames. In an embodiment, the information can be exchanged during an association process. In an embodiment, the AP provides the information in the information elements (IEs) of beacon frames.

As mentioned earlier, the ability of different NPCA-capable AP/STAs to receive and decode an OBSS PPDU may vary depending on their geographic location and/or their components. As such, even if NPCA-capable AP/STAs maintain an OBSS information set for more refined NPCA operations, if the NPCA-capable AP/STAs do not have information regarding the different receiving and decoding abilities of other NPCA-capable AP/STAs, they may have difficulty determining which NPCA-capable AP/STAs can receive and decode the NPCA information included in a particular OBSS PPDU transmitted by an OBSS with an arbitrary rate or modulation scheme. It is recognized by the present disclosure that NPCA-capable AP/STAs need information regarding the highest rate or highest modulation coding scheme receivable by other NPCA-capable AP/STAs from different OBSSs in order to properly determine whether the other NPCA-capable AP/STAs can perform NPCA after overhearing a OBSS PPDU.

Thus, in an embodiment, NPCA-capable AP/STAs additionally maintain information regarding the highest rate or highest modulation coding scheme with which they can receive PPDUs transmitted by different OBSSs and share this information with other NPCA-capable AP/STAs. The NPCA-capable AP/STAs may also maintain information regarding whether they can obtain NPCA information from the PHY preambles of PPDUs transmitted by different OBSSs and share this information with other NPCA-capable AP/STAs.

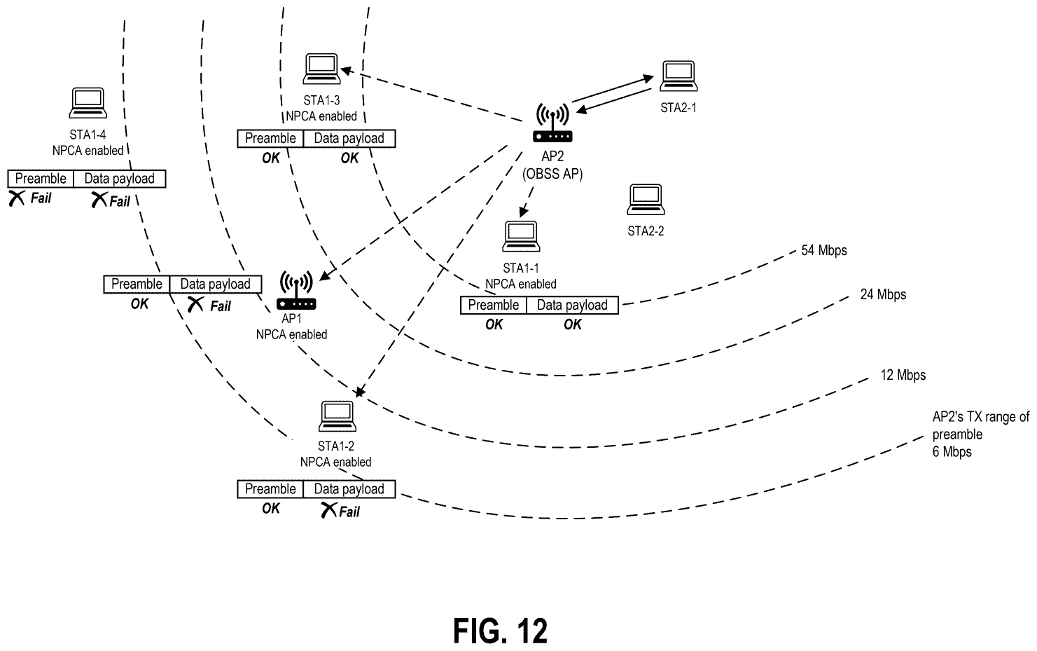

FIG. 12 is a diagram showing how different APs/STAs can have different abilities to receive and decode a PPDU depending on their geographic location, according to some embodiments.

As shown in the diagram, a wireless network includes AP1, STA1-1, STA1-2, STA1-3, and STA1-4, which are all NPCA-capable AP/STAs that belong to the same BSS (BSS1). The wireless network further includes AP2, STA2-1, and STA2-2, which belong to BSS2. BSS2 may be considered as an OBSS with respect to BSS1.

AP1, STA1-1, STA1-2, and STA1-3 may have information regarding BSS2/AP2 in their OBSS information sets (because they are within AP2's preamble transmission range) and may perform NPCA based on decoding PPDUs transmitted by OBSS AP2. However, STA1-4 is outside AP2's transmission range and thus does not have information regarding BSS2/AP2 in its OBSS information set. In the example network topology, the transmission ranges within which a given receiver can decode a PPDU transmitted by AP2 for different transmission rates are shown in dotted lines.

Assume AP2 transmits a non-HT format PPDU (e.g., including a control frame) at a rate of 24 Mbps. In this case, STA1-1 and STA1-3 may be able to receive and decode the PPDU in this example network topology because they are within AP2's 24 Mbps transmission range. AP1 and STA1-2 are not able to decode the data payload of the PPDU but they may be able to receive and decode the non-HT PHY preamble of the PPDU, which is transmitted at a rate of 6 Mbps. Since STA1-4 is outside of AP2's transmission range, it may not be able to receive the PPDU.

As illustrated in this example, a NPCA-capable AP/STA's ability to receive and decode the preamble and data payload of a OBSS PPDU can vary depending on the PPDU format and the rate and/or modulation coding scheme with which the PPDU is transmitted by the OBSS.

Thus, even if AP1 is aware of the existence of the OBSS operated by AP2 and has an OBSS information set that includes information regarding BSS2/AP2, the ability of AP1 to decode PPDUs transmitted by AP2 can vary depending on the PPDU format and the rate or modulation coding scheme with which AP2 transmit the PPDUs. More detailed examples of this situation are described below.

Two scenarios are considered. The first scenario is one where the PPDU has a PPDU format that provides sufficient information to make channel switching decisions for NPCA (e.g., OBSS color information and OBSS channel occupancy duration) in the PHY preamble such as the HE/EHT/UHR PPDU formats. The second scenario is one where the PPDU has a PPDU format that does not provide sufficient information to make channel switching decisions for NPCA in the PHY preamble such as non-HT/HT/VHT PPDU formats.

The PHY preamble of a UHR PPDU may include various information needed for making channel switching decisions for NPCA such as BSS color information, (actual) TXOP duration information, operating bandwidth information, and punctured channel information. As an example of the first scenario, if AP1 receives a 24 Mbps UHR PPDU transmitted by AP2, although AP1 might not be able to decode the data payload of the PPDU (since AP1 is outside of the 24 Mbps transmission range of AP2), AP1 may be able to decode the PHY preamble of the PPDU, which provides sufficient information to allow AP1 to decide whether it can perform NPCA during transmission of the PPDU. Thus, in the first scenario, being able to decode the PHY preamble of the PPDU, which is transmitted at a relatively low rate of 6 Mbps, is sufficient to allow AP1 to determine whether it can perform NPCA.

As an example of the second scenario, if AP1 receives a 24 Mbps non-HT PPDU (e.g., that includes a RTS control frame) transmitted by AP2, AP1 may be able to receive and decode the legacy PHY preamble of the PPDU but might not be able to decode the data payload of the PPDU. However, the legacy PHY preamble may not provide sufficient information to allow AP1 to make channel switching decisions for NPCA (apart from the information included in the L_LENGTH field). Thus, AP1 may decide that it is better not to perform NPCA. As such, when the OBSS PPDU has a PPDU format that does not provide NPCA information in the PHY preamble, being able to decode the MAC field of the data payload is crucial for making channel switching decisions for NPCA.

Another example scenario can be considered. Assume STA1-2 had previously detected the existence of AP2 (which is an OBSS AP from the perspective of STA1-2) based on overhearing PPDUs transmitted by AP2 in the HE/EHT/UHR PPDU formats and updated its OBSS information set accordingly. Also, assume that AP2 subsequently transmits a PPDU having a non-HT PPDU format (e.g., carrying a control frame), which does not provide sufficient NPCA information in its PHY preamble. If this PPDU is transmitted with a rate of 12 Mbps, AP1 may be able to decode the entre PPDU and determine that NPCA can be performed based on the NPCA information included in the OBSS PPDU. However, STA1-2 may not be able to obtain sufficient NPCA information from the PHY preamble of the non-HT OBSS PPDU because the NPCA information is included in the data payload of the PPDU, which STA1-2 is unable to decode (since STA1-2 is outside of AP2's 12 Mbps transmission range). As a result, STA1-2 lacks sufficient NPCA information to determine whether it can perform NPCA and thus may decide not to perform NPCA (and remain on the primary channel). Now, suppose AP1 has received STA1-2's OBSS information set, which includes information regarding AP2's BSS (BSS2). In such a situation, AP1 may incorrectly assume that STA1-2 is also capable of performing NPCA, and thus switch channels (e.g., to the NPCA primary channel) and attempt to perform NPCA with STA1-2, which will be unsuccessful.

As illustrated by the example scenarios provided above, even if NPCA-capable APs/STAs exchange their OBSS information set with each other, they may not be able to recognize the differences in their abilities to decode arbitrary PPDUs transmitted by an OBSS with different rates/MCSs. As such, according to some embodiments, upon overhearing an OBSS PPDU, each NPCA-capable AP/STA not only determines whether it can perform NPCA itself but also determines whether the peer AP/STA with which the NPCA-capable AP/STA intends to perform NPCA with can also perform NPCA.

The present disclosure describes a solution to address the scenario where different NPCA-capable AP/STAs reach different channel switching decisions due to the NPCA-capable AP/STAs having different decoding abilities. With the solution described herein, NPCA-capable APs/STAs may maintain additional information in their OBSS information sets that can be updated/accumulated when they overhear OBSS PPDUs. The NPCA-capable AP/STAs may share the OBSS information that they collect with other NPCA-capable AP/STAs. The solution provides a way to make channel switching decisions for NPCA using the locally generated OBSS information set as well as OBSS information sets shared by other NPCA-capable AP/STAs. In doing so, NPCA-capable AP/STAs can avoid the inefficiencies that may occur when switching channels for NPCA solely based on the NAV duration indicated by OBSS PPDUs, minimize power consumption, and enhance the overall network efficiency.

In an embodiment, the solution involves three stages. In the first stage, the NPCA-capable AP/STAs may maintain information regarding their own ability to receive and decode PPDUs from OBSSs and their own ability to obtain NPCA information from the preambles of OBSS PPDUs. In the second stage, the NPCA-capable AP/STAs may share their OBSS information sets with each other. In the third stage, the NPCA-capable AP/STAs may determine whether NPCA is possible based on the gathered OBSS information sets.

From the perspective of a given NPCA-capable AP/STA, the OBSS information set maintained by the NPCA-capable AP/STA based on information obtained from overheard OBSS PPDUs may be referred to herein as the local OBSS information set and the OBSS information sets shared by other NPCA-capable AP/STAs with the NPCA-capable AP/STA may be referred to herein as peer OBSS information sets.

Stage 1: Maintain Information Regarding Own Ability to Receive and Decode PPDUs from OBSSs and Obtain NPCA Information from the Preambles of OBSS PPDUs

When a NPCA-capable AP/STA overhears a PPDU transmitted by an adjacent OBSS, it may obtain NPCA information from the overheard PPDU.

In an embodiment, a NPCA-capable AP/STA maintains additional information in its OBSS information set regarding the maximum receivable rates or MCSs from different OBSSs and whether NPCA information can be obtained from the preamble of PPDUs transmitted by different OBSSs. For example, the OBSS information set may include a rate column/field or MCS column/field to indicate the maximum rate or MCS with which the NPCA-capable AP/STA is able to receive a PPDU from an OBSS. Also, the OBSS information set may include a “NPCA info from preamble” column/field to indicate whether the NPCA-capable AP/STA is able to obtain NPCA information from the PHY preamble of a PPDU transmitted by an OBSS. As will be described in additional detail herein, having this information may help avoid the situation where different NPCA-capable AP/STAs make different channel switching decisions for NPCA due to having differing decoding abilities (e.g., as illustrated in FIG. 12).

Some PPDU formats provide NPCA information in the PHY preamble. If a NPCA-capable AP/STA is able to obtain the necessary NPCA information from the preamble of a PPDU transmitted by a particular OBSS (e.g., a PPDU transmitted by an OBSS AP), the NPCA-capable AP/STA may set the “NPCA info from preamble” field for the OBSS in its OBSS information set to “Yes.” Otherwise, if the NPCA-capable AP/STA is not able to obtain the necessary NPCA information from the preamble, the NPCA-capable STA may set the “NPCA info from preamble” field for the OBSS in its OBSS information set to “No.”

When NPCA-capable AP/STAs receive an OBSS PPDU, their ability to decode the PPDU may vary depending on the rate or modulation coding scheme with which the PPDU was transmitted (e.g., depending on the MCS or rate in the case of non-HT formats). As the NPCA-capable AP/STA moves further away (e.g., in terms of geographical distance) from the transmitter of the OBSS PPDU, the likelihood of decoding payloads transmitted with a high rate or high MCS decreases. In an embodiment, a NPCA-capable AP/STA may record the highest rate or MCS with which it has received NPCA information from the PPDU. This information may be recorded in the “Maximum receivable rate of non-HT PPDU” or “Maximum receivable MCS” field for the OBSS in its OBSS information set and may be updated whenever an OBSS PPDU with a higher rate or MCS is received from the OBSS.

Table 2 provides an example of an OBSS information set that includes the proposed fields/information. For non-HT PPDUs, rate information may be provided instead of MCS information. The rate information may be obtained from a control frame. For other PPDU formats (e.g., HT/VHT/HE/EHT/UHR PPDU formats), MCS information may be provided. Each NPCA-capable AP/STA may individually maintain such an OBSS information set, which they can then use for making channel switching decisions for NPCA.

TABLE 2

| | | | | Maximum | |
|---|---|---|---|---|---|
| | | | | receivable | |
| | | | | rate (e.g., | MCS |
| OBSS | | | | for non-HT | (ex. For |
| information | | Primary | NPCA Info | PPDUs (e.g., | HT/VHT/HE/ |
| (BSS | Operation | channel | from | Ctrl | EHT/UHR |
| Color/OBSSID) | Bandwidth | number | preamble | frame)) | PPDUs) |
| BSS2 | 320 MHz | 55 | Yes | 12 Mbps | 7 (64-QAM) |
| | | | (HE/EHT/UHR+ | | |
| | | | @) | | |
| BSS6 | 160 MHz | 61 | No | 6 Mbps | 4 (16-QAM) |

### Stage 2: Sharing OBSS Information Set

For successful NPCA operations, NPCA-capable AP/STAs that wish to perform NPCA with each other should have NPCA information that is as identical as possible. Also, they should have decoding abilities that are as identical as possible regarding specific phenomena and PPDU reception events.

In a distributed deployment environment, when NPCA-capable STAs overhear an OBSS PPDU, the AP needs to know which of its associated STAs are able to perform NPCA based on the information included in the OBSS PPDU. Also, the non-AP STAs need to know whether its associated AP can perform NPCA based on the information included in the OBSS PPDU.

To achieve this, NPCA-capable AP/STAs that belong to the same BSS may exchange their OBSS information sets with each other. In general, the AP should know the OBSS information sets of its associated NPCA-capable STAs, while a NPCA-capable non-AP STA should at least be aware of the AP's OBSS information set. An OBSS information set may have a format similar to Table 2 and may be updated based on OBSS PPDUs transmitted by OBSS APs from which NPCA information can be obtained/inferred.

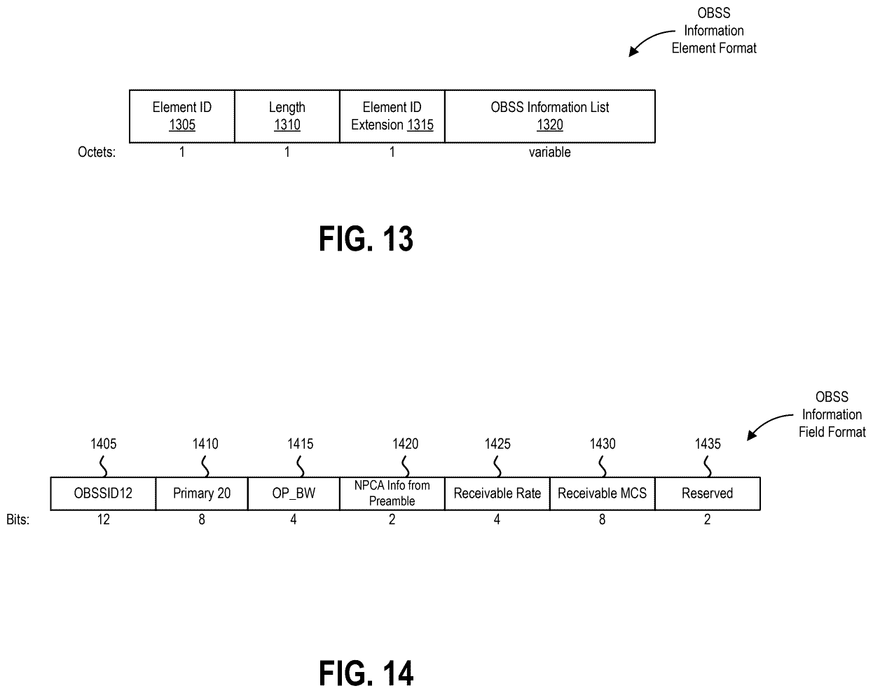

NPCA-capable AP/STAs may exchange OBSS information sets with each other through management frames. A new information element (IE) field can be defined as show in FIG. 13 to carry the OBSS information set in frames such as beacon frames, probe request/response frames, and/or association request/response frames.

FIG. 13 is a diagram showing an OBSS information element format, according to some embodiments.

As shown in the diagram, the OBSS information element includes an element ID field 1305 (1 octet), a length field 1310 (1 octet), an element ID extension field 1315 (1 octet), and an OBSS information list field 1320 (variable length). It should be appreciated that the IE/field formats shown in this diagram and other diagrams are provided by way of example to illustrate a particular embodiment. Other embodiments may use different IE/field formats (e.g., having more or less fields, a different order of fields, and/or different field lengths).

The OBSS information list field 1320 may contain information regarding the OBSS information set maintained by the transmitting NPCA-capable AP/STA. The OBSS information list field 1320 may include one or more OBSS information fields, each containing information regarding a particular OBSS included in the OBSS information set maintained by the transmitting NPCA-capable AP/STA. FIG. 14 shows an example OBSS information field format.

FIG. 14 is a diagram showing OBSS information field format, according to some embodiments.

As shown in the diagram, the OBSS information field may include an OBSSID12 field 1405 (12 bits), a primary 20 field 1410 (8 bits), an operating bandwidth (OP_BW) field 1415 (4 bits), a NPCA info from preamble field 1420 (2 bits), a receivable rate field 1425 (4 bits), a receivable MCS field 1430 (8 bits), and a reserved field 1435 (2 bits).

The OBSSID12 field 1405 may include an ID of an OBSS. The ID of the OBSS may be a part of the bit stream of the BSSID or the BSS color.

The primary 20 field 1410 may include an indication of the primary 20 MHz channel (e.g., the channel number) used by the OBSS indicated in the OBSSID12 field 1405.

The OP_BW field 1415 may include an indication of the maximum bandwidth that the OBSS indicated in the OBSSID12 field 1405 can operate on.

The NPCA info by preamble field 1420 may include an indication of whether NPCA information can be obtained from the preamble of a PPDU transmitted by the OBSS indicated in the OBSSID12 field 1405.

The receivable rate field 1425 may include an indication of the highest rate with which non-HT format PPDUs transmitted by the OBSS indicated in the OBSSID12 field 1405 can be received.

The receivable MCS field 1430 may include an indication of the highest MCS with which PPDUs (excluding non-HT PPDU formats) transmitted by the OBSS indicated in the OBSSID12 field 1405 can be received.

In an embodiment, OBSS information sets can be exchanged using an action frame, which is a type of management frame.

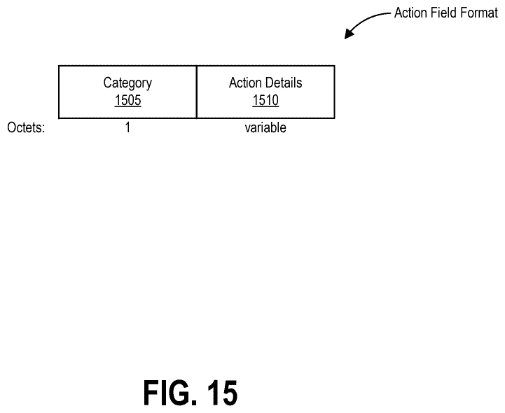

FIG. 15 is a diagram showing an action field format, according to some embodiments.

As shown in the diagram, the action field may include a category field 1505 (1 octet) and an action details field 1510 (variable length). The action field may be included in the body of an action frame.

The category field 1505 may include a value between 0 and 255, with values of “35-125” and “128-255” being reserved for future use. In an embodiment, one of the currently reserved values can be allocated for indicating that the action field provides an OBSS information set. The action details field 1510 may include the OBSS information element shown in FIG. 13 and described above.

### Phase 3: Determine Whether NPCA is Possible Based on the Gathered OBSS Information Sets

An AP operating a BSS may initiate NPCA by providing a channel switching notification to a NPCA-capable STA associated with the AP using a trigger frame or similar frame. However, NPCA operations are determined and performed while OBSS PPDUs are occupying the primary channel. As such, explicit notification may not be feasible, and each NPCA-capable AP/STA needs to be able to independently make channel switching decisions for NPCA upon overhearing an OBSS PPDU. Also, all NPCA-capable AP/STAs that wish to participate in NPCA should be able to independently reach the same channel switching decision, otherwise NPCA may fail.

It is challenging for a NPCA-capable AP/STA and its potential intended receiver within the BSS to accurately recognize whether they will both switch to the NPCA primary channel. As mentioned earlier, explicit notification or direct signaling to coordinate channel switching is not possible. Therefore, to independently make as identical decisions as possible in a distributed environment, the NPCA-capable AP/STAs should have as much identical information as possible.

For NPCA-capable AP/STAs to make independent and distributed channel switching decisions for NCPA, they should compare their own OBSS information set with the OBSS information set shared by the NPCA-capable peer AP/STA, and ensure that both sides will make the same channel switching decision for NPCA. It is assumed that, as proposed in phase 2 (sharing OBSS information phase), NPCA-capable AP/STAs belonging to the same BSS have shared their OBSS information sets with each other.

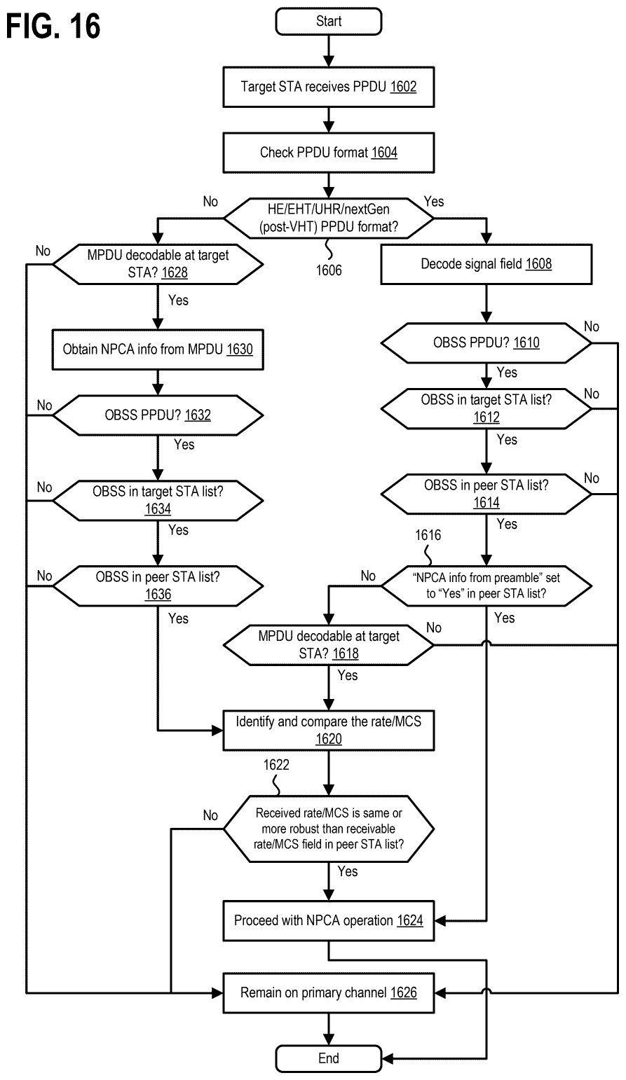

FIG. 16 is a flow diagram showing a method for determining whether to perform NPCA, according to some embodiments.

In the flow diagram, the NPCA-capable AP/STA that receives/overhears a PPDU and is deciding whether to perform NPCA based on the received/overheard PPDU is referred to as the target STA. Also, in the flow diagram, the peer NPCA-capable AP/STA with which the target STA wishes to perform NPCA is referred to as the peer STA.

As shown in the diagram, the flow may start at operation 1602, where the target STA receives a PPDU.

At operation 1604, the target STA checks the PPDU format of the received PPDU. If the signal field cyclic redundancy check (CRC) fails, the PPDU format cannot be identified. At operation 1606, if the PPDU has a HE, EHT, UHR, or next generation (post-VHT) PPDU format, then the flow may move to operation 1608. Otherwise, the flow may move to operation 1628.

At operation 1608, the target STA decodes the signal field of the received PPDU. The target STA may determine whether the PPDU is an OBSS PPDU based on information included in the preamble of the PPDU. At operation 1610, if the PPDU is an OBSS PPDU, the flow may move to operation 1612. Otherwise, if the PPDU is not an OBSS PPDU, the flow may move to operation 1626, at which the target STA decides not to perform NPCA with the peer STA but to remain on the primary channel.

At operation 1612, if the OBSS that transmitted the PPDU is included in the target STA's OBSS information set (e.g., which may be in the form of a list or table), the flow may move to operation 1614. Otherwise, if the OBSS that transmitted the PPDU is not included in the target STA's OBSS information set, then the flow may move to operation 1626, at which the target STA decides not to perform NPCA with the peer STA but to remain on the primary channel.

At operation 1614, if the OBSS that transmitted the PPDU is included in the peer STA's OBSS information set (e.g., which may be in the form of a list or table), the flow may move to operation 1616. Otherwise, if the OBSS that transmitted the PPDU is not included in the peer STA's OBSS information set, then the flow may move to operation 1626, at which the target STA decides not to perform NPCA with the peer STA but to remain on the primary channel.

At operation 1616, if the “NPCA info from preamble” field is set to “Yes” for the OBSS in the peer STA's OBSS information set, then the flow may move to operation 1624, at which the target STA decides to perform NPCA with the peer STA (e.g., based solely on NPCA information obtained from the preamble of the PPDU). Otherwise, if the “NPCA info from preamble” field is set to “No” for the OBSS in the peer STA's OBSS information set, then the flow may move to operation 1618.

At operation 1618, if the target STA is able to decode the MPDU included in the PPDU, the flow may move to operation 1620. Otherwise, if the target STA is not able to decode the MPDU included in the PPDU, the flow may move to operation 1626, at which the target STA decides not to perform NPCA with the peer STA but to remain on the primary channel.

At operation 1620, the target STA identifies the rate/MCS with which the PPDU was transmitted and compares the identified rate/MCS with the receivable rate/MCS for the OBSS indicated in the peer STA's OBSS information set. Depending on the PPDU format, the rate/MCS information can be found in the HE SIG field, EHT SIG field, UHR SIG field, etc.

At operation 1622, if the received rate/MCS is the same or more robust than the receivable rate/MCS for the OBSS indicated in the peer STA's OBSS information set (which means that the peer STA should be able to decode the MPDU), the flow may move to operation 1624, at which the target STA decides to perform NPCA with the peer STA (e.g., based on NPCA information obtained from the MPDU). Otherwise, if the received rate/MCS is less robust (e.g., higher rate or higher MCS) than the receivable rate/MCS for the OBSS indicated in the peer STA's OBSS information set (which means the peer STA cannot decode the MPDU), the flow may move to operation 1626, at which the target STA decides not to perform NPCA with the peer STA but to remain on the primary channel.

As mentioned earlier with regard to operation 1606, if the received PPDU does not have a HE, EHT, UHR, or next generation (post-VHT) PPDU format, then the flow may move to operation 1628.

At operation 1628, if the target STA is able to decode the MPDU included in the PPDU, the flow may move to operation 1630. Otherwise, if the target STA is not able to decode the MPDU included in the PPDU, the flow may move to operation 1626, at which the target STA decides not to perform NPCA with the peer STA but to remain on the primary channel.

At operation 1630, the target STA may obtain NPCA information from the MPDU, including information regarding which BSS transmitted the PPDU.

At operation 1632, if the PPDU is an OBSS PPDU, the flow may move to operation 1634. Otherwise, if the PPDU is not an OBSS PPDU, the flow may move to operation 1626, at which the target STA decides not to perform NPCA with the peer STA but to remain on the primary channel.

At operation 1634, if the OBSS that transmitted the PPDU is included in the target STA's OBSS information set, the flow may move to operation 1636. Otherwise, if the OBSS that transmitted the PPDU is not included in the target STA's OBSS information set, then the flow may move to operation 1626, at which the target STA decides not to perform NPCA with the peer STA but to remain on the primary channel.

At operation 1636, if the OBSS that transmitted the PPDU is included in the peer STA's OBSS information set, the flow may move to operation 1620. Operation 1620 and the operations that follow may be performed, as described above. Otherwise, if the OBSS that transmitted the PPDU is not included in the peer STA's OBSS information set, then the flow may move to operation 1626, at which the target STA decides not to perform NPCA with the peer STA but to remain on the primary channel.

Each NPCA-capable STA can independently make channel switching decisions for NPCA using the method shown in the flow diagram.

An example of a NPCA-capable STA making channel switching decisions for NPCA when overhearing an OBSS PPDU is now described in the context of an example network topology.

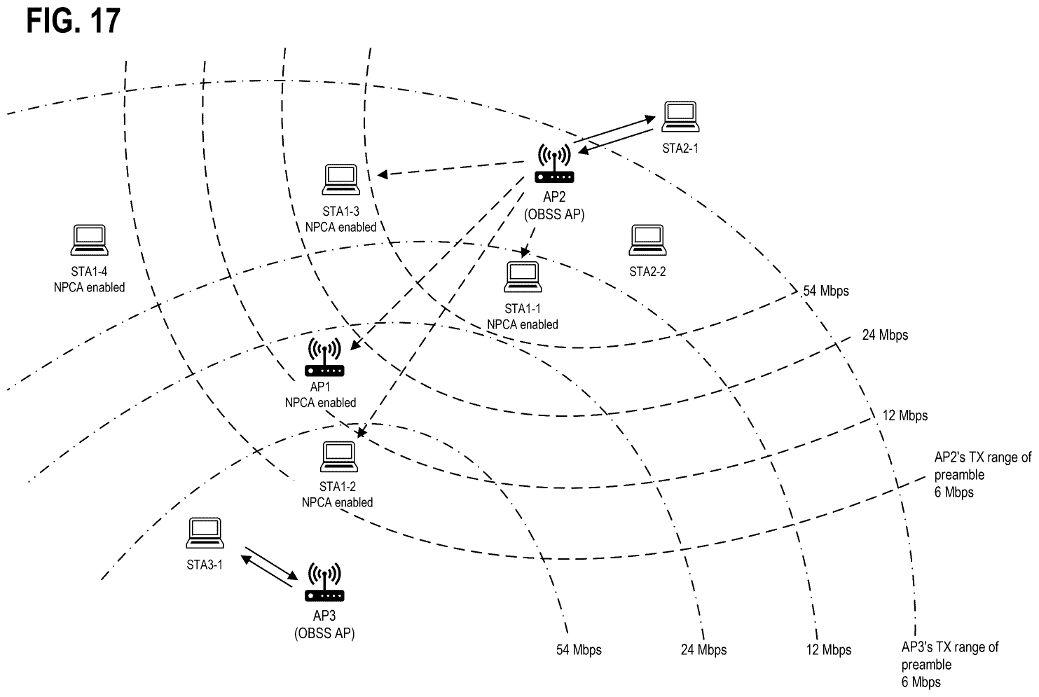

FIG. 17 is a diagram showing an example network topology, according to some embodiments.

As shown in the diagram, the wireless network includes a first BSS (“BSS1”) that includes NPCA-capable AP/STAs including AP1, STA1-1, STA1-2, STA1-3, and STA1-4.

The wireless network further includes a second BSS (“BSS2”) and a third BSS (“BSS3”), which are OBSSs with respect to BSS1. BSS2 may include AP2 and STA2-1. BSS3 may include AP3 and STA3-1.

It is assumed in this example that the BSS1 AP/STAs can perform NPCA after decoding PPDUs transmitted by OBSS APs. The diagram shows the transmission ranges of each OBSS AP for different transmission rates in dashed lines (the transmission ranges of AP2 are shown in dashed lines and the transmission ranges of AP3 are shown in dash-dotted lines). The outermost dashed line with respect to an AP represents the maximum transmission range within which a receiving STA can decode a preamble transmitted by the AP.

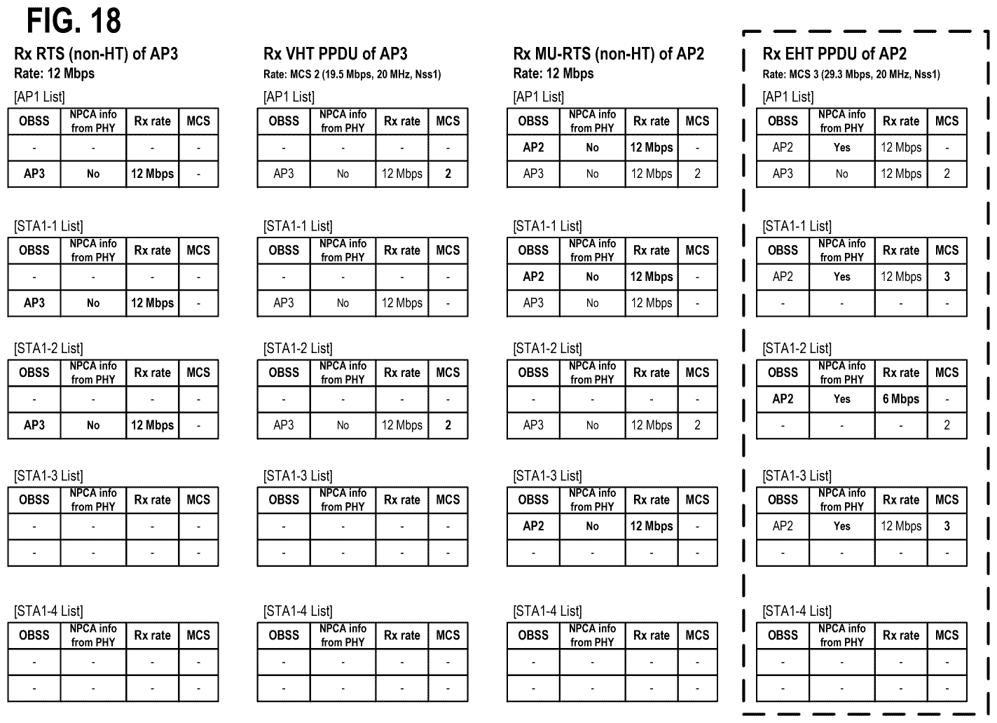

FIG. 18 is a diagram showing how the OBSS information sets of the BSS1 AP/STAs are updated upon overhearing OBSS PPDUs, according to some embodiments.

It is assumed that the OBSS information set for each NPCA-capable AP/STA belonging to BSS1 has been initialized. The OBSS information sets may be updated as the AP/STAs overhear PPDUs transmitted by OBSSs (e.g., BSS2 and BSS3). It is assumed in this example that AP3 and STA3-1 exchange RTS/CTS frames and then exchange data/response frames. Subsequently, AP2 and STA2-1 may exchange (MU-)RTS/CTS frames and then exchange data/response frames. As previously mentioned, the OBSS information sets maintained by the BSS1 APs/STAs may be updated whenever NPCA information can be obtained from the PPDUs transmitted by an OBSS AP.

When AP3 transmits a RTS frame in a non-HT PPDU format at using a 12 Mbps rate, AP1, STA1-1, and STA1-2 may update their OBSS information sets since they are within the 12 Mbps transmission range of AP3 (as shown in FIG. 17). Since NPCA information cannot be obtained from the PHY preamble, AP1, STA1-1, and STA1-2 may set the corresponding field (“NPCA info from PHY”—which may be equivalent to the “NPCA info from preamble” field) for BSS3/AP3 in their OBSS information sets to “No.” Also, they may set the receivable rate (Rx rate) field for BSS3/AP3 in their OBSS information sets to 12 Mbps.

Subsequently, when AP3 transmits a VHT PPDU using MCS2, only AP1 and STA1-2 update their OBSS information sets because the transmission rate is close to 20 Mbps (and only AP1 and STA1-2 are within the 20 Mbps transmission range of AP3). AP1 and STA1-2 may set the (receivable) MCS field for BSS3/AP3 in their OBSS information sets to “MCS2.”

Subsequently, when AP2 transmits a MU-RTS frame in a non-HT PPDU format using a 12 Mbps rate, the NPCA-capable AP/STAs within AP2's 12 Mbps transmission range are AP1, STA1-1, and STA1-3. Since the PPDU has a non-HT PPDU format, NPCA information cannot be obtained from the PHY preamble but can be obtained from the MPDU included in the PPDU. Thus, AP1, STA1-1, and STA1-3 add an entry in their OBSS information sets for BSS2/AP2 with the OBSS ID field set to OBSS2/AP2, the rate field set to 12 Mbps, and the “NPCA info from PHY” field set to “No.”

Subsequently, when AP2 transmits an EHT PPDU using MCS3, the EHT PPDU may include NPCA information in the PHY preamble. Thus, the NPCA-capable AP/STAs that are within the preamble transmission range (which in this example are AP1, STA1-1, STA1-2, and STA1-3) may update their OBSS information sets accordingly (e.g., update the “NPCA info from PHY” field to “Yes”). STA1-1 and STA1-3 are able to decode the entire EHT PPDU so they may set the MCS field for BSS2/AP2 to MCS3. When the OBSS information set is updated using only the preamble, it is considered that the receivable rate of the receiving AP/STA is 6 Mbps, so the rate field can be set to 6 Mbps.

STA1-4 is not within the preamble transmission range of AP2 so it does not update its OBSS information set. STA1-4 could not receive NPCA information from a preamble, nor could it decode the payload containing the MPDU to obtain OBSS information. As such, STA1-4's OBSS information set is empty and it cannot perform NPCA in the current example network topology.

As a result, as shown by the dashed line box in the diagram, each NPCA-capable AP/STA has configured and updated its OBSS information set after overhearing the OBSS PPDUs/frames. AP1 may share its OBSS information set with its associated STAs (STA1-1, STA1-2, STA1-3, and STA1-4) through a management frame (e.g., beacon frame). Also, each of the STAs associated with AP1 may share their OBSS information sets with AP1 through a management frame.

Assume a scenario where the OBSS information sets have been updated and shared between AP1 and the non-AP STAs associated with AP1. Now, if an arbitrary PPDU is transmitted by an OBSS or when a transmission opportunity (TXOP) sequence occurs in an OBSS, a NPCA-capable AP/STA belonging to BSS1 may make channel switching decisions for NPCA based on information obtained from the OBSS PPDU and its own information (the information included in the NPCA-capable AP/STA's own OBSS information set and the OBSS information sets shared by other AP/STA(s)).

An example is now described to demonstrate that the solution can make correct channel switching decisions for NPCA. For example, consider a situation where the AP2 transmits an initial control frame (ICF) to initiate a TXOP sequence in BSS2. The NPCA-capable AP/STAs belonging to BSS1 have the OBSS information sets encompassed within the dashed line box on the right side of FIG. 18. Suppose that the ICF transmitted by AP2 is transmitted using a non-HT PPDU format with a rate of 24 Mbps. AP1 may be able to decode the preamble of the PPDU but cannot decode the data payload. This is reflected in AP1's OBSS information set, which indicates that AP1's maximum receivable rate for BSS2/AP2 is 12 Mbps. Thus, when AP1 overhears the ICF transmitted by AP2, it cannot obtain NPCA information from the ICF/PPDU and thus may decide not to perform NPCA. STA1-1 and STA1-3, which are within the 24 Mbps transmission range of AP2, may be able to receive and decode the ICF and obtain NPCA information from the ICF/PPDU.

Now, suppose STA1-1 and STA1-3 are unaware of the maximum receivable rate of APL. If the OBSS information set shared by AP1 lacks information regarding the receivable rate/MCS, STA1-1 and STA1-3 would assume that AP1 can perform NPCA based on overhearing AP2's PPDU transmission (because BSS2/AP2 is listed in AP1's OBSS information set). From this it can be seen that if the OBSS information set does not include information regarding the receivable rate/MCS for different OBSSs, a proper decision regarding NPCA operation may not be made.

A NPCA-capable AP/STA may not be able to predict how an OBSS will transmit a PPDU in terms of the modulation scheme or rate with which the PPDU is transmitted. As such, the NPCA-capable AP/STA should have sufficient information that allows it to make an independent decision of whether a peer NPCA-capable AP/STA will be able to perform NPCA based on overhearing the same PPDU. Also, NPCA operations should be performed while maintaining well-aligned and shared information among STAs. The present disclosure describes certain information that each NPCA-capable AP/STA can maintain and share with its peer AP/STAs to enable efficient NPCA operations. NPCA-capable AP/STAs in a distributed environment may use the information (e.g., receivable rate/MCS information) to independently make the same channel switching decisions for performing NPCA.

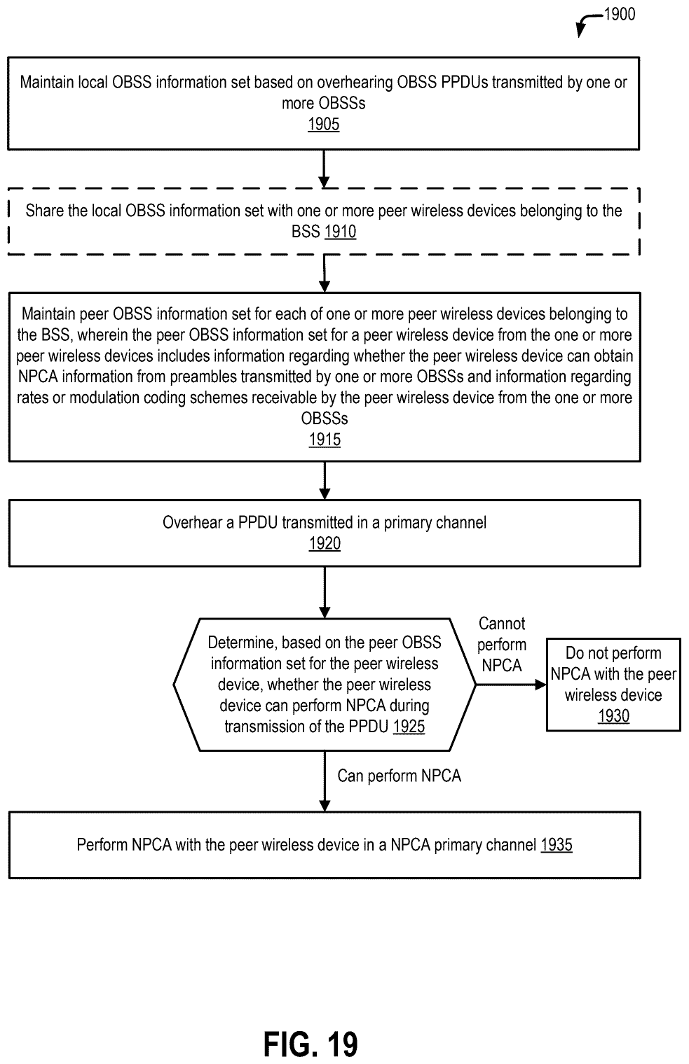

Turning now to FIG. 19, a method 1900 will be described for performing NPCA, in accordance with an example embodiment. The method 1900 may be performed by a wireless device (e.g., wireless device 104) that belongs to a BSS. The wireless device may have joined the BSS before performing the method.

Additionally, although shown in a particular order, in some embodiments the operations of the method 1900 (and the other methods shown in the other figures) may be performed in a different order. For example, although the operations of the method 1900 are shown in a sequential order, some of the operations may be performed in partially or entirely overlapping time periods.

At operation 1905, the wireless device maintains a local OBSS information set based on overhearing OBSS PPDUs transmitted by one or more OBSSs.

In an embodiment, at operation 1910, the wireless device shares the local OBSS information set with one or more peer wireless devices belonging to the BSS. In an embodiment, sharing the local OBSS information set with the one or more peer wireless devices comprises transmitting a frame that includes one or more OBSS information fields (e.g., using the format shown in FIG. 14), wherein each of the one or more OBSS information fields includes an OBSS identifier of an OBSS, information regarding whether the wireless device can obtain NPCA information from a preamble transmitted by the OBSS, and information regarding a rate or modulation scheme receivable by the wireless device from the OBSS. In an embodiment, the frame that includes the one or more OBSS information fields is a management frame. In an embodiment, the frame that includes the one or more OBSS information fields is an action frame.

At operation 1915, the wireless device maintains a peer OBSS information set for each of one or more peer wireless devices belonging to the BSS, wherein the peer OBSS information set for a peer wireless device from the one or more peer wireless devices includes information regarding whether the peer wireless device can obtain NPCA information from preambles transmitted by one or more OBSSs and information regarding rates or modulation coding schemes receivable by the peer wireless device from the one or more OBSSs. In an embodiment, the information regarding whether the peer wireless device can obtain NPCA information from the preambles can be omitted (e.g., it can be inferred that if the peer OBSS information set for the peer wireless device includes information regarding an OBSS then the peer wireless device is able to obtain NPCA information from the preamble transmitted by the OBSS). In an embodiment, the peer OBSS information set for the peer wireless device further includes OBSS identifiers of the one or more OBSSs, information regarding operation bandwidths of the one or more OBSSs, and information regarding primary channels for the one or more OBSSs.

At operation 1920, the wireless device overhears a PPDU transmitted in a primary channel.

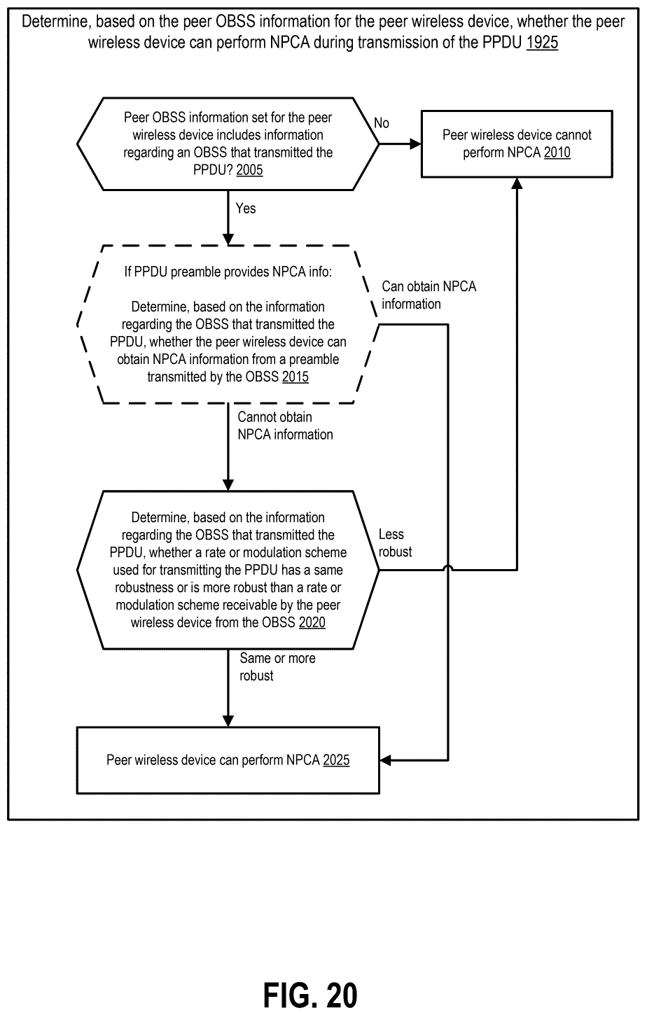

At operation 1925, the wireless device determines, based on the peer OBSS information set for the peer wireless device, whether the peer wireless device can perform NPCA during transmission of the PPDU. Operation 1925 may involve one or more of the operations shown in FIG. 20 and described in further detail herein below. If the wireless device determines that the peer wireless device cannot perform NPCA, the flow may move to operation 1930, at which the wireless device does not perform NPCA with the peer wireless device. Otherwise, if the wireless device determines that the peer wireless device can perform NPCA, the flow may move to operation 1935, at which the wireless device performs NPCA with the peer wireless device in a NPCA primary channel (which may be a predesignated channel or otherwise agreed upon channel for performing NPCA).

FIG. 20 is a diagram showing operations for determining whether the peer wireless device can perform NPCA during transmission of the PPDU, according to some embodiments.

As shown in the diagram, operation 1925 may involve one more of operations 2005-2025.

At operation 2005, the wireless device determines whether the peer OBSS information set for the peer wireless device includes information regarding an OBSS that transmitted the PPDU. If the peer OBSS information set for the peer wireless device does not include information regarding the OBSS that transmitted the PPDU, then the flow may move to operation 1620, where the wireless device determines that the peer wireless device cannot perform NPCA. Otherwise, if the peer OBSS information set for the peer wireless device includes information regarding the OBSS that transmitted the PPDU, then the flow may move to operation 2015 or operation 2020.

Operation 2015 may be performed if the PPDU preamble provides NPCA information. In an embodiment, at operation 2015, the wireless device determines, based on the information regarding the OBSS that transmitted the PPDU, whether the peer wireless device can obtain NPCA information from a preamble transmitted by the OBSS that transmitted the PPDU. If the wireless device determines that the peer wireless device can obtain the NPCA information from the preamble, then the flow may move to operation 2025, at which the wireless device determines that the peer wireless device can perform NPCA. Otherwise, if the wireless device determines that peer wireless device can obtain the NPCA information from the preamble, then the flow may move to operation 2020.

At operation 2020, the wireless device determines, based on the information regarding the OBSS that transmitted the PPDU, whether a rate or modulation scheme used for transmitting the PPDU has a same robustness or is more robust than a rate or modulation scheme receivable by the peer wireless device from the OBSS that transmitted the PPDU. If the wireless device determines that the rate or modulation scheme used for transmitting the PPDU is less robust than the rate or modulation scheme receivable by the peer wireless device from the OBSS that transmitted the PPDU, then the flow may move to operation 2010, at which the wireless device determines that the peer wireless device cannot perform NPCA. Otherwise, if the wireless device determines that the rate or modulation scheme used for transmitting the PPDU has the same robustness or is more robust than the rate or modulation scheme receivable by the peer wireless device from the OBSS that transmitted the PPDU, then the flow may move to operation 2025, where the wireless device determines that the peer wireless device can perform NPCA.

Although many of the solutions and techniques provided herein have been described with reference to a WLAN system, it should be understood that these solutions and techniques are also applicable to other network environments, such as cellular telecommunication networks, wired networks, etc. In some embodiments, the solutions and techniques provided herein may be or may be embodied in an article of manufacture in which a non-transitory machine-readable medium (such as microelectronic memory) has stored thereon instructions which program one or more data processing components (generically referred to here as a “processor” or “processing unit”) to perform the operations described herein. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components.

In some cases, an embodiment may be an apparatus (e.g., an AP STA, a non-AP STA, or another network or computing device) that includes one or more hardware and software logic structures for performing one or more of the operations described herein. For example, as described herein, an apparatus may include a memory unit, which stores instructions that may be executed by a hardware processor installed in the apparatus. The apparatus may also include one or more other hardware or software elements, including a network interface, a display device, etc.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system may carry out the computer-implemented methods described herein in response to its processor executing a computer program (e.g., a sequence of instructions) contained in a memory or other non-transitory machine-readable storage medium. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method performed by a wireless device belonging to a basic service set (BSS) to perform non-primary channel access (NPCA), the method comprising:
maintaining local overlapping basic service set (OBSS) information set based on overhearing OBSS physical layer protocol data units (PPDUs) transmitted by one or more OBSSs;
maintaining a peer OBSS information set for each of one or more peer wireless devices belonging to the BSS, wherein the peer OBSS information set for a peer wireless device from the one or more peer wireless devices includes information regarding whether the peer wireless device can obtain NPCA information from preambles transmitted by one or more OBSSs and information regarding rates or modulation coding schemes receivable by the peer wireless device from the one or more OBSSs;
overhearing a PPDU transmitted in a primary channel;
determining, based on the peer OBSS information set for the peer wireless device, whether the peer wireless device can perform NPCA during transmission of the PPDU; and
responsive to determining that the peer wireless device can perform NPCA, performing NPCA with the peer wireless device in a NPCA primary channel.

2. The method of claim 1, wherein the peer OBSS information set for the peer wireless device further includes OBSS identifiers of the one or more OBSSs, information regarding operation bandwidths of the one or more OBSSs, and information regarding primary channels for the one or more OBSSs.

3. The method of claim 1, further comprising:
sharing the local OBSS information set with the one or more peer wireless devices.

4. The method of claim 3, wherein the sharing the local OBSS information set with the one or more peer wireless devices comprises transmitting a frame that includes one or more OBSS information fields, wherein each of the one or more OBSS information fields includes an OBSS identifier of an OBSS, information regarding whether the wireless device can obtain NPCA information from a preamble transmitted by the OBSS, and information regarding a rate or modulation scheme receivable by the wireless device from the OBSS.

5. The method of claim 4, wherein the frame that includes the one or more OBSS information fields is a management frame.

6. The method of claim 4, wherein the frame that includes the one or more OBSS information fields is an action frame.

7. The method of claim 1, wherein the PPDU has a PPDU format that provides NPCA information in a preamble of the PPDU, wherein the determining whether the peer wireless device can perform NPCA during the transmission of the PPDU comprises:
determining whether the peer OBSS information set for the peer wireless device includes information regarding an OBSS that transmitted the PPDU; and
responsive to determining that the peer OBSS information set for the peer wireless device includes information regarding the OBSS that transmitted the PPDU, determining, based on the information regarding the OBSS that transmitted the PPDU, whether the peer wireless device can obtain NPCA information from a preamble transmitted by the OBSS that transmitted the PPDU.

8. The method of claim 7, wherein the determining whether the peer wireless device can perform NPCA during the transmission of the PPDU further comprises:
responsive to determining that the peer wireless device cannot obtain NPCA information from the preamble transmitted by the OBSS that transmitted the PPDU, determining, based on the information regarding the OBSS that transmitted the PPDU, whether a rate or modulation scheme used for transmitting the PPDU has a same robustness or is more robust than a rate or modulation scheme receivable by the peer wireless device from the OBSS that transmitted the PPDU, wherein the peer wireless device is determined as being able to perform NPCA if the rate or modulation scheme use for transmitting the PPDU has the same robustness or is more robust than the rate or modulation scheme receivable by the peer wireless device from the OBSS that transmitted the PPDU.

9. The method of claim 1, wherein the PPDU does not have a PPDU format that provides NPCA information in a preamble of the PPDU, wherein the determining whether the peer wireless device can perform NPCA during the transmission of the PPDU comprises:
determining whether the peer OBSS information set for the peer wireless device includes information regarding an OBSS that transmitted the PPDU; and
responsive to determining that the peer OBSS information set for the peer wireless device includes information regarding the OBSS that transmitted the PPDU, determining, based on the information regarding the OBSS that transmitted the PPDU, whether a rate or modulation scheme used for transmitting the PPDU has a same robustness or is more robust than a rate or modulation scheme receivable by the peer wireless device from the OBSS that transmitted the PPDU, wherein the peer wireless device is determined as being able to perform NPCA if the rate or modulation scheme use for transmitting the PPDU has the same robustness or is more robust than the rate or modulation scheme receivable by the peer wireless device from the OBSS that transmitted the PPDU.

10. A wireless device to perform non-primary channel access (NPCA), the wireless device comprising:
a radio frequency transceiver;
a memory device storing a set of instructions; and
a processor coupled to the memory device, wherein the set of instructions, when executed by the processor, causes the wireless device to:
join a basic service set (BSS);
maintain local overlapping basic service set (OBSS) information set based on overhearing OBSS physical layer protocol data units (PPDUs) transmitted by one or more OBSSs;
maintain a peer OBSS information set for each of one or more peer wireless devices belonging to the BSS, wherein the peer OBSS information set for a peer wireless device from the one or more peer wireless devices includes information regarding whether the peer wireless device can obtain NPCA information from preambles transmitted by one or more OBSSs and information regarding rates or modulation coding schemes receivable by the peer wireless device from the one or more OBSSs;
overhear a PPDU transmitted in a primary channel;
determine, based on the peer OBSS information set for the peer wireless device, whether the peer wireless device can perform NPCA during transmission of the PPDU; and
responsive to determining that the peer wireless device can perform NPCA, perform NPCA with the peer wireless device in a NPCA primary channel.

11. The wireless device of claim 10, wherein the set of instructions, wherein the peer OBSS information set for the peer wireless device further includes OBSS identifiers of the one or more OBSSs, information regarding operation bandwidths of the one or more OBSSs, and information regarding primary channels for the one or more OBSSs.

12. The wireless device of claim 10, wherein the set of instructions, when executed by the processor, further causes the wireless device to:
share the local OBSS information set with the one or more peer wireless devices.

13. The wireless device of claim 10, wherein the sharing of the local OBSS information set with the one or more peer wireless devices comprises transmitting a frame that includes one or more OBSS information fields, wherein each of the one or more OBSS information fields includes an OBSS identifier of an OBSS, information regarding whether the wireless device can obtain NPCA information from a preamble transmitted by the OBSS, and information regarding a rate or modulation scheme receivable by the wireless device from the OBSS.

14. The wireless device of claim 13, wherein the frame that includes the one or more OBSS information fields is a management frame.

15. The wireless device of claim 13, wherein the frame that includes the one or more OBSS information fields is an action frame.

16. The wireless device of claim 10, wherein the PPDU has a PPDU format that provides NPCA information in a preamble of the PPDU, wherein the determining whether the peer wireless device can perform NPCA during the transmission of the PPDU comprises:
determining whether the peer OBSS information set for the peer wireless device includes information regarding an OBSS that transmitted the PPDU; and
responsive to determining that the peer OBSS information set for the peer wireless device includes information regarding the OBSS that transmitted the PPDU, determining, based on the information regarding the OBSS that transmitted the PPDU, whether the peer wireless device can obtain NPCA information from a preamble transmitted by the OBSS that transmitted the PPDU.

17. The wireless device of claim 16, wherein the determining whether the peer wireless device can perform NPCA during the transmission of the PPDU further comprises:
responsive to determining that the peer wireless device cannot obtain NPCA information from the preamble transmitted by the OBSS that transmitted the PPDU, determining, based on the information regarding the OBSS that transmitted the PPDU, whether a rate or modulation scheme used for transmitting the PPDU has a same robustness or is more robust than a rate or modulation scheme receivable by the peer wireless device from the OBSS that transmitted the PPDU, wherein the peer wireless device is determined as being able to perform NPCA if the rate or modulation scheme use for transmitting the PPDU has the same robustness or is more robust than the rate or modulation scheme receivable by the peer wireless device from the OBSS that transmitted the PPDU.

18. The wireless device of claim 12, wherein the PPDU does not have a PPDU format that provides NPCA information in a preamble of the PPDU, wherein the determining whether the peer wireless device can perform NPCA during the transmission of the PPDU comprises:
determining whether the peer OBSS information set for the peer wireless device includes information regarding an OBSS that transmitted the PPDU; and
responsive to determining that the peer OBSS information set for the peer wireless device includes information regarding the OBSS that transmitted the PPDU, determining, based on the information regarding the OBSS that transmitted the PPDU, whether a rate or modulation scheme used for transmitting the PPDU has a same robustness or is more robust than a rate or modulation scheme receivable by the peer wireless device from the OBSS that transmitted the PPDU, wherein the peer wireless device is determined as being able to perform NPCA if the rate or modulation scheme use for transmitting the PPDU has the same robustness or is more robust than the rate or modulation scheme receivable by the peer wireless device from the OBSS that transmitted the PPDU.

19. A non-transitory machine-readable medium having computer code stored therein, which when executed by a processor of a wireless device belonging to a basic service set (BSS), causes the wireless device to perform operations comprising:
maintaining local overlapping basic service set (OBSS) information set based on overhearing OBSS physical layer protocol data units (PPDUs) transmitted by one or more OBSSs;
maintaining a peer OBSS information set for each of one or more peer wireless devices belonging to the BSS, wherein the peer OBSS information set for a peer wireless device from the one or more peer wireless devices includes information regarding whether the peer wireless device can obtain NPCA information from preambles transmitted by one or more OBSSs and information regarding rates or modulation coding schemes receivable by the peer wireless device from the one or more OBSSs;
overhearing a PPDU transmitted in a primary channel;
determining, based on the peer OBSS information set for the peer wireless device, whether the peer wireless device can perform NPCA during transmission of the PPDU; and
responsive to determining that the peer wireless device can perform NPCA, performing NPCA with the peer wireless device in a NPCA primary channel.

20. The non-transitory machine-readable medium of claim 19, wherein the peer OBSS information set for the peer wireless device further includes OBSS identifiers of the one or more OBSSs, information regarding operation bandwidths of the one or more OBSSs, and information regarding primary channels for the one or more OBSSs.
